(19) United States
(12) Patent Application Publication
(10) Pub. No.: US 2017/0330279 A1
(43) Pub. Date: Nov. 16, 2017

(54) Unified Option Trading System

(71) Applicant: Hector Jose Maximiliano Ponzone, Souix Falls, SD (US)

(72) Inventor: Hector Jose Maximiliano Ponzone, Souix Falls, SD (US)

(21) Appl. No.: 15/526,565

(22) PCT Filed: Nov. 16, 2015
(86) PCT No.: PCT/US15/60918

§ 371 Date: May 12, 2017

Related U.S. Application Data
(60) Provisional application No. 62/080,127, filed on Nov. 14, 2014.

(51) Int. Cl. G06Q 40/04; G06Q 20/06; G06Q 40/06

(52) U.S. Cl. CPC G06Q 40/04; G06Q 40/06; G06Q 20/0658; G06Q 2220/00

(57) ABSTRACT

A unified option trading system allows a user non-spreadsheet based access to an extended set of data relating to options trading, including allowing positions to be displayed in a calculator format which allows easy comparison of multiple positions and easy manipulation of variables relating to a given position to test different related scenarios, as well as trading in cryptocurrency. The unified option trading system also keeps track of relevant numbers as they apply in real time to a multitude of strategies to serve a traders specific strategies. The unified system also offers uniform population of data across different modules, uniform display of icons for quick recognition of a position and easy access to positions via messaging. Options for a product may be displayed in a chain, each populating a calculator automatically, multiple trading accounts, an option prediction calculator, and a market scanning module which scans for desired options.

### RELATED APPLICATION(S)

This application claims the priority and benefit from copending U.S. Provisional Patent application 62/080,127 in the name of the same inventor, and having the same title, and filed upon Nov. 14, 2014, the entire specification of which is incorporated herein by this reference.

### FIELD OF THE INVENTION

The present invention relates to financial software systems, in particular to systems adapted to obtain, calculate, display and retain data for options trading.

### BACKGROUND

Investors seeking to manage their portfolios of stock options find themselves with few good option trading management packages.

The most common packages are those offered by commercial trading platforms, which naturally enough have to offer some sort of platform for option trading. These packages typically will have traditional tracking tools that are limited to a standardized number tracking approach which makes it difficult for the trader to track their income without cumbersome calculations. This traditional tracking method does not address directly the particular number tracking needs of traders utilizing strategies such as covered calls or collars. Relevant numbers are presented in a manner that needs to be re assed every time in order to adapt them to a particular strategy. Closed positions numbers are difficult to track due to the same reason stated above, at least as far as the user's access to the software is concerned. There is memory of closed positions within the traditional platform software but there is no way to track the user's changes in a single position across time according to the needs of the trader involved in a particular strategy.

Other fairly obvious functionality is generally not present, for example, it is usually difficult or impossible to take an open (much less closed) position and “play around with the numbers” in a format that allows a user to examine how their profits would change with a change in market price, a change in date, percentage of tax liability and so on.

Even more, it is usually cumbersome to compare different open positions. Thus a user has a very clear interest in comparing options of different financial products, such as stock options in two different corporations, and yet it can be difficult to put the numbers side-by-side and it is not apparently known to allow two groups of numbers, once compared, to be changed with hypothetical changes in circumstances.

In addition, most option trading software packages suffer from a lack of summary displays providing the user with a simplified, iconographic overview of their situation as it pertains to a particular strategy such as covered calls, collars, synthetic calls, and so on. In addition, most option trading software package lack even such basics as a uniform system of icons throughout, population between different subroutines and displays, or even such elements as graphical displays (bar charts, pie charts, etc.) of the information presented numerically. All graphic information in traditional platforms presents a global view of the trades that needs to be distilled into a system that presents the numbers in a relevant manner that targets addresses a trader's individual approach and needs.

In general, most option traders will seek to use spreadsheet software to fill the gap. Spreadsheets at least allow a slow process of customization which can be implemented by the users themselves in order to provide a greater range of numbers arranged according to individual needs, however, this still leaves users with the difficulty of getting comparative displays between unrelated products, easy recalculation based on hypothetical circumstances, and most especially the difficulty of maintaining a relational database of closed positions.

It would be preferable to provide a uniform, integrated option trading package which allows easy display and storage of positions in a calculable format allowing users to “play with the numbers” and study different possibilities. It would further be preferable to provide a system which allows users to predict, with some accuracy, the financial results of a given investment across time and even provides some degree of estimation of the value of a given option and/or position, if the value of the underlying financial product (stock) changes.

It would further be preferable to provide a uniform, integrated option/position trading package which allows users to compare, side by side, such positions.

It would further be preferable to provide a uniform, integrated option trading package which populates financial data across different types of displays.

It would further be preferable to provide a uniform, integrated option trading package which would track the financial condition of a given position by means of certain categories (above the strike price, above the breakeven price, etc.).

It would further be preferable to provide a uniform, integrated option trading package which maintains an easily accessed database of closed positions arranged and displayed in a manner that correlates with an individual's needs according to his/her strategy and needs.

It would further be preferable to provide a uniform, integrated option trading package which maintains such closed positions not only in a chronological or product based format but also in a relational chain showing each modification in order as it is made to a given position.

It would further be preferable to provide a uniform, integrated option trading package which allows direct access of a given position or display simply by means of a link to the position or display of interest.

It would further be preferable to provide a uniform, integrated option trading package which allows users to customize display of two or more financial products in a single display which shows both, in a formal further allowing manipulation of the numbers to study different possible scenarios.

It would further be preferable to provide a uniform, integrated option trading package which has a system of icons indicating statuses and which uses consistent formats, user interface skins, and icons throughout the suite.

It would further be preferable to provide a uniform, integrated option trading package which allows instant display of financial data in chart form that is arranged according to an individual's needs and strategy and also correlates to every other part of the suite.

### SUMMARY OF THE INVENTION

The present invention teaches that a unified option trading system may provide to a user, in a non-spreadsheet form, access to an extremely complete set of data and tools relating to options trading.

In aspects this includes allowing options positions to be displayed in a calculator format which calculator format is based upon the exact nature of the option itself, so that a covered call position will have a different calculator display format than a collar position. The calculator display format furthermore allows easy comparison of multiple positions and easy manipulation of variables relating to a given position to test different scenarios related thereto. Thus a user with an option position displayed might elect to have that position be manipulated to reflect a higher present stock price or a different tax liability, with results which would immediately propagate through the rest of the system by means of the unified position data structure of the invention. The calculator can be used in at least three different modes: first a small mode, taking up less space on a display and optimized to allow a user to place several calculators side-by-side for comparison of different financial investments, different scenarios and the like. Secondly, the calculator has a large mode offering the ability to display quite a bit of detailed information and alter it and recalculate it as needed for the same purpose of comparison. Thirdly there is another unrelated calculator. The compound calculator may allow a user to inspect a time-based (longitudinal) display of the financial results of a given investment: for example, in year 7, month 2, how much principal will have accrued, and so on. Note that the “compound calculator” is not related to other two calculators in any way. This calculator may be used to figure out investment strategy or what a particular goal will be.

The unified option trading system also offers the ability to retain and display closed positions, including not just chronologically ordered positions but also positions displayed in a chain of trades as the positions evolved over time. Since a user is likely to roll one position in a financial product into a modified new position in a financial product, such a “history chain” of previous positions becomes a valuable tool for analysis by the user. Beyond that, the history chain represents a linked series of positions taken by the user in the past. Note that these positions may in fact even be directly linked, that is, the user terminated one position and entered into the next one in the same transaction. This analytic allows a user to get a longitudinal view of their own past behavior, data, and results with regard to the chain of options they are interested in. In contrast to tools which either do not save any closed positions or save them but allow them only to be accessed alphabetically or in some other way, these positions are shown in a useful and usable relational chain which keeps track of all changes made to a position over time.

The unified system also offers uniform population of data across different modules, uniform display of icons for quick recognition of a position and easy access to positions via messaging.

The system furthermore offers the use of standard graph types (pie charts, line charts, etc.) which are often lacking in known systems, allows messages which may link directly from the message to a given position without the necessity to pass through numerous other positions or displays and so on.

The system allows a bridge module to display additional information, a pair of scanner modules, one options scanner to update and create new positions in the system based not only on stock ticker prices but on an extensive array of additional information which a user can select and then to display a selection (not to be confused with the “history chain”) of potential option investments which meet the investors particular criteria, and a second “market” scanner for general market information: stock quotes, market business news and so on. The “option scanner” and the “market scanner” should not be confused. The system also offers a summary module which displays a group of positions in a fast format to read, including a uniform iconography. The market scanner module may furthermore provide the ability to scan the market for a particular type of option desired, that is, for a collar or a covered call, or perhaps even for more esoteric types such as an iron butterfly or the like.

The present system teaches other advantages and embodiments, including the ability for a single individual to maintain multiple trading accounts and to switch between those accounts without logging out, for example, switching between an IRA (tax advantaged trading account) and a regular account.

The present system furthermore teaches the use of crypto currencies (such as Bitcoin) and more importantly, the payment system provided with crypto currencies.

The present system may furthermore be used for tracking of ordinary stocks or other similar financial products rather than options.

The platform may allow for the use of crypto currencies to buy and sell securities and all type of options as well as other financial instruments such as futures and commodities. One of its functions may be to act as a bridge in a transaction initiated with a crypto currency and requiring a standard currency on the other end, thus facilitating the transaction on both ends. The system may auto convert the value of a given crypto currency into the designated monetary value of choice (US dollars, AUS Dollars, Euros etc) to facilitate the transaction between currencies. The system may track and account all fluctuations in market value of the chosen crypto and target standard currencies and automatically make the necessary changes to adjust for changes in buying power as transactions are performed in the designated end currency. The system may also allow for transactions purely based in crypto currencies on both sides when and if crypto currencies are accepted by the current financial system. The system may have the ability to take a crypto currency e.g. through a Bitcoin wallet, on one and end and automatically convert the value of the bitcoins into the required currency required by the other party e.g. US dollars, Euros, etc in order to complete the transaction. The system may deal and account for all the technical details necessary to make sure that all transactions are secure and cannot be double charged e.g. waiting the necessary amount of time to ensure that all bitcoin input transactions are sufficiently deep within the block chain in order to avoid fraud.

These, and other, embodiments of the invention will be better appreciated and understood when considered in conjunction with the following description and the accompanying drawings. It should be understood, however, that the following description, while indicating various embodiments of the invention and numerous specific details thereof, is given by way of illustration and not of limitation. Many substitutions, modifications, additions and/or rearrangements may be made within the scope of the invention without departing from the spirit thereof, and the invention includes all such substitutions, modifications, additions and/or rearrangements.

### SUMMARY IN REFERENCE TO THE CLAIMS

It is thus a first aspect, objective, embodiment and advantage of the present invention to provide a unified option trading system, for use in managing a portfolio having a plurality of positions in a plurality of financial products in at least a first market, each of the positions in turn having dates for action associated therewith and a position type associated therewith, the unified option trading system comprising:

a summary module, the summary module operative to track each of such positions and each of such dates and furthermore to display each of such positions and each of such dates;

a calculator module operative to spawn a plurality of calculator module instances;

a plurality of calculator module instance types, each calculator module instance type being selected from the group consisting of: call, put, call spread, put spread, married put, collars, covered calls, puts, synthetic covered calls, naked calls, naked puts, straddle, strangle, calendar, diagonal, butterfly, iron butterfly, condor, iron condor, combo, futures options, futures spreads, futures option spreads, fence, barrier options, American option, Asian option, Bermudan option, Boston option, Canary option, European option, Israeli option, Russian option, Verde option, Parisian option, capped-style option, compound option, shout option, double option, swing option, exotic option, cross option, quanto option, exchange option, basket option, rainbow option, low exchange price option, lookback option, binary option, chooser option, forward start option, cliquet option and combinations thereof;

a plurality of calculator module instance data structure types, each calculator module instance data structure type being associated with one calculator module instance type;

first and second calculator instances spawned by the calculator module, each calculator instance having one calculator instance module type and one calculator module instance data structure, and displaying respective first and second of such positions, the calculator module when spawning the calculator instances automatically assigning the appropriate calculator instance module type thereto based upon such position types associated with such positions;

each calculator instance having two display modes, a smaller display mode and a larger display mode, and displaying in the larger mode account, sector, industry, stock purchase price, number of shares, call strike, call expiry, put strike, put expiry, dividend, stock commissions, options commissions, regulatory fees, stock current price, earnings date, ex-dividend date, position type, date of entry, status, gross premium, days held, number of options contracts, total capital investment, total capital investment with fees, total fees, in the money intrinsic value, in the money loss, capital gains per share, total capital gains, effective premium, effective premium if exercised, breakeven maximum risk dollar amount, maximum risk percentage, ROI percentage, ROI if exercised, average monthly ROI, annualized ROI, income, income if exercised, tax liability, tax liability if exercised, current breakeven price, current strike price, and original strike price;

a position overview module having the first and second calculator instances displayed therein, side by side, thus allowing easy comparison between such first and second positions;

an open positions editing module displaying a third such position which is open, such third position being in a third financial product, and furthermore displaying an option chain of such positions, associated with such third financial product, the open positions editing module further operative to allow changes to such third position, in particular, each of such positions in the option chain being an active link operative when selected to activate the calculator module and spawn a new calculator instance automatically populated with data from such selected position;

a closed positions module retaining and displaying a fourth such position which is closed, such fourth position being in a fourth financial product, and furthermore displaying a history chain of such closed positions associated with such fourth financial product, the closed positions having active links to one another, the closed positions module further displaying a chronological index linked to such positions;

a market scanner module operative to search such first market by means of an electronic network according to a first set of selectable parameters and to return any market data which matches the first set of parameters and to update the unified option trading system;

an option scanner module operative to search such first market by means of an electronic network according to a second set of selectable parameters and to return any additional such options available on such first market which match the second set of parameters and to update the option chain with such additional options;

a bridge module operative to calculate and display at least one member selected from the group consisting of: reserve capital, starting capital, percent stock, currency of display, max permissible positions per sector, max permissible positions per industry, deposited funds, withdrawn funds, open income, closed income, open capital investment, closed capital investment, current capital, remaining capital, starting account value, current account value, account tax open positions, account tax closed positions, account tax open and closed positions, average risk per position expressed as an amount of currency, average risk per position expressed as a percentage of position value, total risk expressed in currency, total fees open positions, total fees closed positions, total fees open and closed positions, total capital gains open positions, total capital gains closed positions, total capital gains open and closed positions, open positions associated with this account, closed positions associated with this account and combinations thereof.

wherein the various modules can access data from other modules and are operative to populate one another;

and further comprising a unified iconography and a unified abbreviation system used by all modules of the unified option trading system;

and further wherein the unified option trading system of the invention is not a spreadsheet.

It is thus a second aspect, objective, embodiment and advantage of the present invention to provide a unified option trading system, further comprising:

a first data field associated with each position, the first data field containing therein an indicator of a first date; wherein the first date is one member selected from the group consisting of: such dates for action, an expiry date, an option date, ex-dividend date, earnings date, date of position entry, length of time position has been open, date position closed, dividend pay date, and combinations thereof.

It is thus another aspect, objective, embodiment and advantage of the present invention to provide a unified option trading system, wherein the uniform iconography further comprises:

a group of symbols, each symbol indicating a status of a position having an original stock price, a current stock price, breakeven price, original strike price, current strike price, management fees and a potential profit, the symbols including:

a) a first symbol indicating current stock price is above the break even and original strike prices;

b) a second symbol indicating the current stock price is such that immediate closing of the position would be profitable;

c) a third symbol indicating that the current stock price is below the break even and original strike prices;

d) a fourth symbol indicating that the current stock price is above the breakeven price but lower than the original strike price due to management of the position;

e) a fifth symbol indicating that the current stock price is above the breakeven price but below the original strike price;

f) a sixth symbol indicating that the current stock price is above the break even and strike prices but due to management of the position the current strike price is below the original strike price;

g) a seventh symbol indicating that the breakeven price is above the original stock price and original strike price but below the current strike price;

h) an eighth symbol indicating that the breakeven price is above the current strike price and the current strike price is above the original stock purchase price and original strike price;

i) a ninth symbol indicating that the current strike price is below the original strike price and the breakeven price is above the original strike price and original stock price.

It is thus another aspect, objective, embodiment and advantage of the present invention to provide a unified option trading system, further comprising:

a help module operative to provide one member selected from the group consisting of: context sensitive explanations, iconography definitions, stock symbol lookup, option type lookup, financial terminology lookup and combinations thereof.

It is thus a first aspect, objective, embodiment and advantage of the present invention to provide a unified option trading system, further comprising:

a position closing module, operative to change an open position to a closed position, and in the event that a position is modified further operative to create a new open position, and add the new position to the associated option chain and add the closed position to the history chain;

an editable notes field associated with each such position, the position closing module further operative to prompt for input of additional information to such editable notes field, including text information, regarding the change in position.

It is thus an additional aspect, objective, embodiment and advantage of the present invention to provide a unified option trading system, further comprising:

an editable notes field associated with each such position and a note input module automatically entering therein the first date, an indication of a position change, the note input module further allowing input of notes to the editable notes field.

It is thus another aspect, objective, embodiment and advantage of the present invention to provide a unified option trading system, further comprising:

a message module operative to send a message, the message containing one member of the group consisting of: a) one such position, b) a link operative to directly display such position without displaying other modules of the option trading system and without displaying other positions, and c) combinations thereof.

It is thus another aspect, objective, embodiment and advantage of the present invention to provide a unified option trading system, further comprising:

a non-volatile memory in a computer processor unit, the option trading system and such positions recorded upon the non-volatile memory, the option trading system further operative to change ownership of an option at opening and closing of an option.

It is thus another aspect, objective, embodiment and advantage of the present invention to provide a unified option trading system, wherein:

the summary module is further operative to track and display at least one member selected from the group consisting of: stock ticker prices, position type, weight per stock in portfolio, sector allocation, industry allocation, income per position, total monthly income, weight of total return per position, portfolio progress through time, amount of open and closed income per position, income realized in closed positions, tax liability, charts based upon the relevant data, such dates for action, an expiry date, an option date, ex-dividend date, earnings date, date of position entry, length of time position has been open, date position closed, dividend pay date, and combinations thereof.

It is thus another aspect, objective, embodiment and advantage of the present invention to provide a unified option trading system, wherein: the first set of selectable parameters used by the market scanner module further comprises: stock price, ROI, down side protection, in-the-money or out-of-the-money options, expiration date, comparisons to moving averages, corporation market cap, corporation earnings, corporation PE ratio, corporation owners, corporation nationality, and combinations thereof;

and the second set of selectable parameters used by the options scanner module further comprises: stock price, ROI, down side protection, in-the-money or out-of-the-money options, expiration date, comparisons to moving averages, corporation market cap, corporation earnings, corporation PE ratio, corporation owners, corporation nationality, and combinations thereof.

It is thus another aspect, objective, embodiment and advantage of the present invention to provide a calculator module for use in an option trading package and for managing a portfolio in at least a first market, the portfolio having a plurality of positions in a plurality of financial products including at least a first and a second position in respective first and second financial products, each of the positions in turn having dates for action associated therewith and a position type associated therewith and a plurality of financial data associated therewith, the calculator module comprising:

a primary module operative to spawn first and second calculator module instances respectively associated with such first and second positions, each calculator module instance being given a calculator module instance type associated with such position type of such financial product, a calculator module instance data structure, a calculator module instance display format;

each calculator module instance having one calculator module instance type, each calculator module instance type being selected from the group consisting of: call, put, call spread, put spread, married put, collars, covered calls, puts, synthetic covered calls, naked calls, naked puts, straddle, strangle, calendar, diagonal, butterfly, iron butterfly, condor, iron condor, combo, futures options, futures spreads, futures option spreads, fence, barrier options, American option, Asian option, Bermudan option, Boston option, Canary option, European option, Israeli option, Russian option, Verde option, Parisian option, capped-style option, compound option, shout option, double option, swing option, exotic option, cross option, quanto option, exchange option, basket option, rainbow option, low exchange price option, lookback option, binary option, chooser option, forward start option, cliquet option and combinations thereof;

each calculator module instance data structure having a calculator module instance data structure type, each calculator module data structure type being associated with one calculator module instance type, each calculator module instance data structure having a subset group of variable fields relevant to such calculator module instance type, the subset group of variable fields containing such plurality of financial data associated with such position;

each calculator module instance display format being associated with one calculator module instance type;

a display module operative in a first mode to display the first calculator module instance using the associated calculator module instance display format, the display module in the first mode displaying at least first and second members of such plurality of financial data associated with such first position;

the calculator module operative to accept an input, the input altering at least one of such displayed members of such plurality of financial data associated with such first position, the calculator module further operative to recalculate all of such plurality of financial data associated with such first position based upon the input;

the display module operative in a second mode to display the first and second calculator module instances using their respective associated calculator module instance display format, the first and second calculator module instances being displayed side by side so as to allow easy comparison of the first and second positions;

the calculator module further comprising a closed positions module retaining and displaying such first position when such first position is closed, and furthermore displaying a chain of retained closed positions associated with such first financial product, the closed positions module further displaying a chronological index linked to such positions.

It is thus another aspect, objective, embodiment and advantage of the present invention to provide a position tracking module for use in an option trading package and for managing a portfolio having a plurality of positions in a plurality of financial products in at least a first market, the plurality of positions including at least a first and a second position in respective first and second financial products, each of the positions in turn having dates for action associated therewith and a position type associated therewith and a plurality of financial data associated therewith, the position tracking module comprising:

a database having a plurality of position data structures, each position data structure having a plurality of data fields, each position data structure being associated with a respective one of such positions;

a first data field of each associated position data structure being an indicator of the type of option trading strategy of such associated position;

a second data field of each associated position data structure being an indicator of the open or closed status of such associated position;

a third data field of each position data structure being an indicator of the identity of such financial product;

a fourth data field of each position data structure being an indicator of one member of the group consisting of: a) a previous such position, if any, in such financial product, which such previous position was altered to create such associated position, b) a later such position, if any, in such financial product, which such later position was created by altering such associated position, and c) combinations thereof;

the database retaining the position data structure associated with every one of such positions both before and after every alteration of such position and regardless of open and closed status, whereby every position ever held is retained in the dataset;

a chronological index of all retained position data structures;

a history chain, the history chain comprising a series of closed position data structures selected from the database, each member of the series of closed position data structures selected for being related to a particular one of such financial products, the closed position data structures of the history chain being linked in order according to the fourth data field of each one of the series of closed position data structures of the history chain;

a calculator module operative to spawn a plurality of calculator module instances, each one of the calculator module instances associated with a respective one position data structure of the option chain;

a message access module operative to send a message and if requested to display a calculator module associated with a respective one of the position data structures of the database without displaying other modules of such option trading package.

It is thus yet another aspect, objective, embodiment and advantage of the present invention to provide a position tracking module, further comprising:

a plurality of calculator module instance types, each calculator module instance having a fifth data field indicating its type, each calculator module instance type being selected from the group consisting of: call, put, call spread, put spread, married put, collars, covered calls, puts, synthetic covered calls, naked calls, naked puts, straddle, strangle, calendar, diagonal, butterfly, iron butterfly, condor, iron condor, combo, futures options, futures spreads, futures option spreads, fence, barrier options, American option, Asian option, Bermudan option, Boston option, Canary option, European option, Israeli option, Russian option, Verde option, Parisian option, capped-style option, compound option, shout option, double option, swing option, exotic option, cross option, quanto option, exchange option, basket option, rainbow option, low exchange price option, lookback option, binary option, chooser option, forward start option, cliquet option and combinations thereof.

It is thus a further aspect, objective, embodiment and advantage of the present invention to provide a position tracking module, further comprising:

a help module operative to provide one member selected from the group consisting of: context sensitive explanations, iconography definitions, stock symbol lookup, option type lookup, financial terminology lookup and combinations thereof.

It is thus a first aspect, objective, embodiment and advantage of the present invention to provide a position tracking module, wherein:

the chronological index further comprises, an index by month and year.

It is thus an aspect, objective, embodiment and advantage of the present invention to provide a position tracking module, wherein:

the position data structures further comprise a sixth data field indicating one member selected from the list consisting of: industry, bid, ask, purchase price, income, tax, commission, breakeven price, premium history, option activity history, dividends, and combinations thereof.

It is thus another aspect, objective, embodiment and advantage of the present invention to provide a position tracking module, further comprising: an option scanner module operative to search such first market by means of an electronic network according to a set of selectable parameters and to return any such options available on such first market which match the set of parameters and to update the option trading package;

the option scanner module operative to display an option chain;

the option chain comprising a list of such options prices associated with a particular one of such financial products, each of such prices in the option chain being an active link operative when selected to activate the calculator module and spawn a new calculator instance automatically populated with data from such selected position.

It is thus another aspect, objective, embodiment and advantage of the present invention to provide a position tracking module, further comprising:

a non-volatile memory in a computer processor unit, the position tracking module and database recorded upon the non-volatile memory, the position tracking module further operative to change ownership of an option at opening and closing of an option.

It is thus another aspect, objective, embodiment and advantage of the present invention to provide a position tracking module, further comprising: a cryptocurrency module operative to display monetary valuations denominated in a cryptocurrency, and further operative to transact trades by way of a cryptocurrency exchange network.

It is thus another aspect, objective, embodiment and advantage of the present invention to provide a position tracking module, further comprising: transacting trades by way of the cryptocurrency exchange network when such trades a denominated in a currency other than the cryptocurrency.

### INDEX TO THE REFERENCE NUMERALS

100 Position
102 Financial product
104 Market
106 Expiry date (date for action)
108 Ex Div date
110 Position type
112 Summary module/command center
114 Calculator module instance in edit mode/larger mode
116 Calculator module instance type
118 Calculator instance, smaller mode
120 Calculator instance, smaller mode
122 Position overview module, closed
124 Position overview module, open
126 Scanner module display
128 Bridge module
130 Icon
132 Unified iconography
134 Help module
136 Active message
138 Link to particular position
140 Alternative message with link to particular position
142 Position type data field
144 Expiry date data field
146 Account name
148 Stock
150 Industry
152 Sector
154 Stock purchase price
156 Number of shares
158 Call Strike
160 Sell to open call premium
162 Buy to open call premium
164 Put strike
166 Put expiry
168 Sell to open put premium
170 Buy to open put premium
172 Dividend per share
174 Stock purchase commission
176 Option commissions
178 Option Reg Fees
180 Early Exit (Delta exit) premium
182 Current stock price
184 Earnings date
186 Ex div Date
188 Div pay date
190 Date of position entry
192 Current status of position (open call, closed put, etc.)
194 Gross premium
196 Number of contracts
198 Total capital investment
200 Total capital investment including fees
202 Total fees
204 Commission costs
206 In the money intrinsic value of call
208 In the money potential capital loss
210 Capital gains per share
212 Total capital gains
214 Effective premium
216 Effective premium if exercised
218 Break even
220 Max risk dollar amount
222 Max risk percentage/Average ROI percentage
224 Average ROI percentage if exercised
226 Average monthly ROI %
228 Annualized ROI %
230 Income
232 Income if exercised
234 Tax liability
236 Tax liability if exercised
238 Editable notes field
240 Compounding calculator module
241 Option scanning module
242 Option chain
246 Market scanning module
248 Market scanning module
250 Closed positions page chronological index
252 Calculate function
254 Early exit function
256 Delete function
258 Close function
300 Electronic network, internet, etc.
302 Market for financial products/server
304 Option seller
306 Mobile device using invention
307 Non-volatile memory with system
308 Computer using invention
400 Unified option trading system
402 Bridge module
404 Summary module
406 Open positions module
408 Closed positions module
410 Options scanner module
412 Market scanner module
414 Help module
416 Position closing module
418 Note module
420 Database
421 Calculator module
422, 424, 426 Calculator instances
428 Message module
500 Predictive calculator
602 Stock Price
604 Uncalled and Called Return %
606 in the Money/out of the Money %
608 PE Ratio
610 Market Cap
612 Volume
614 Open Interest
616 52-week Range
618 Broker Rating
620 Insider Owner %
622 Revenue per Year
624 Bare Cash
626 Debt
628 Basic Materials
630 Consumer Goods
632 Conglomerates
634 Financial
636 Health
638 Industrial Goods
640 Services
642 Technologies
644 Utilities
646 S&P 500
648 S&P 200
650 S&P 100
652 DJIA
654 DJIA 30
656 DJIA 10
658 ETFs
660 Leveraged ETFs
2300 Network
2302 Cryptocurrency network
2304 Traditional currency denominated trading house

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a view of a command center or home page module of the invention.

FIG. 2 is a view of a help function displaying a unified iconography of position statuses of the invention.

FIG. 3 is a view of a calculator module and display of the invention in the edit mode.

FIG. 4 is a view of the quote lists; market scanning module and graphing capability of the calculator module of the invention.

FIG. 5 is a view of an alternative embodiment of the market scanning module of the invention.

FIG. 6 is a view of another alternative embodiment of the market scanning module of the invention.

FIGS. 7A and 7B are of an exemplary data structure showing searchable fields which may be used by the option scanner function user when laying out a search for potential investment opportunities.

FIG. 8 is a view of an option chain search function in operation and a calculator module of the invention in option chain mode with the option chain operating.

FIG. 9 is a view of some of the functionality of the calculator module of the invention.

FIG. 10 is a view of an auto note module of the invention, showing the prompt to make notes on why position changes have been made, thus enhancing the effectiveness of retaining the automatic notes of all changes made to a position.

FIG. 11 is a view of an open positions display of the invention.

FIG. 12 is a view of a closed positions display of the invention showing a chronological index of past positions.

FIG. 13 is a view of one possible, simplified view of a bridge page.

FIG. 14 is a view of a calculator module of the invention in yet another mode of operation, “schedule mode”, showing possible compounded future earnings, withdrawals, tax liabilities and the like.

FIG. 15 is a view of a reminder/alert message of the invention, showing active links directly to positions of interest.

FIG. 16 is a view of a view of an alternative embodiment of a reminder/alert message of the invention.

FIG. 17a is a view of part of an exemplary data structure for a position within the database of the invention.

FIG. 17b is a view of the remainder part of the data structure for a position within the database of the invention.

FIG. 18 is a block diagram of a network system showing a market, an option seller, and two devices using the invention: a mobile device and a computer.

FIG. 19 is a structural diagram of one possible embodiment of the modules of the invention, exemplary only.

FIG. 20 is a diagram of a scanner module which is used to find a position in the market which matches parameters input by the user.

FIG. 21 is a diagram of a predictive calculator which provides to a user a prediction about value or other variables relating to a position based upon variable values entered by the user.

FIG. 22 is a hierarchical diagram showing the logic for presentation of different status markers or status symbols used uniformly throughout the unified trading system of the invention.

FIG. 23 is a block diagram of another aspect of the present invention, the ability of the invention to serve as a network bridge from a user who wishes to carry out trades in a cryptocurrency to a trading house which uses actual legal tender, or to simply trade in cryptocurrency.

FIG. 24 is a diagram of a scenario tool module of the invention.

### DETAILED DESCRIPTION OF EMBODIMENTS

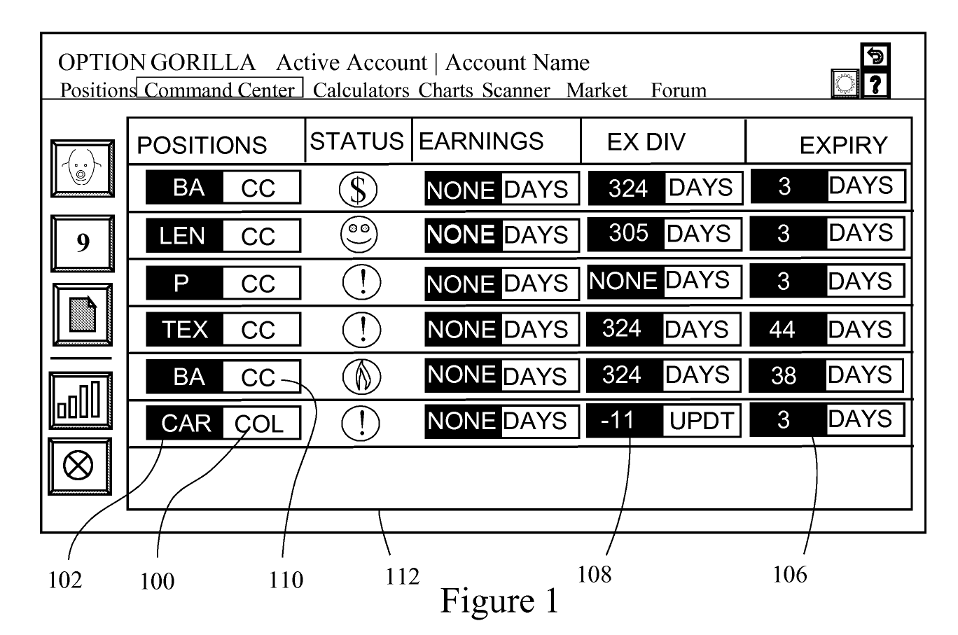

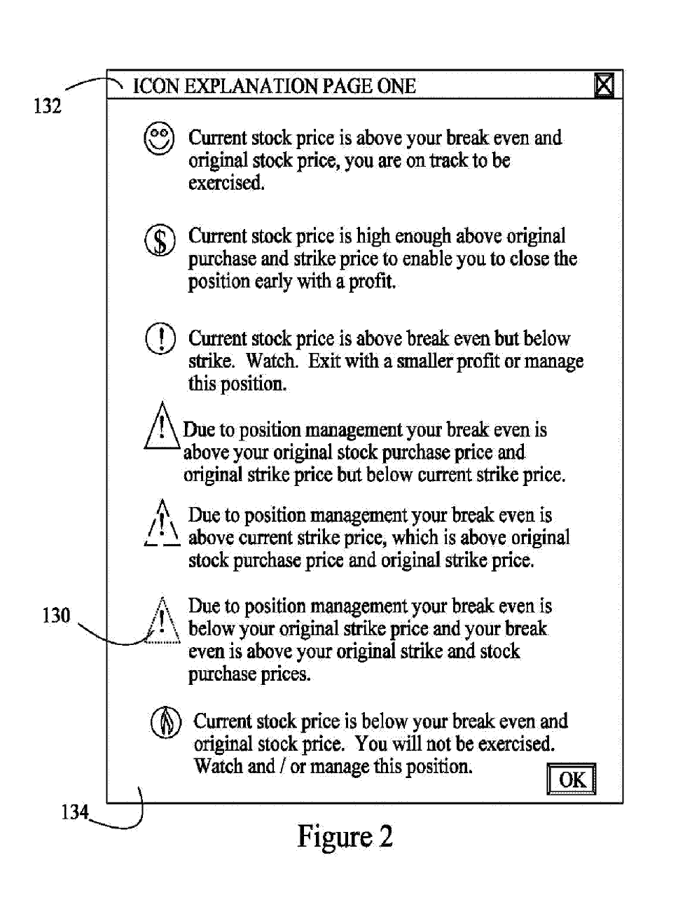

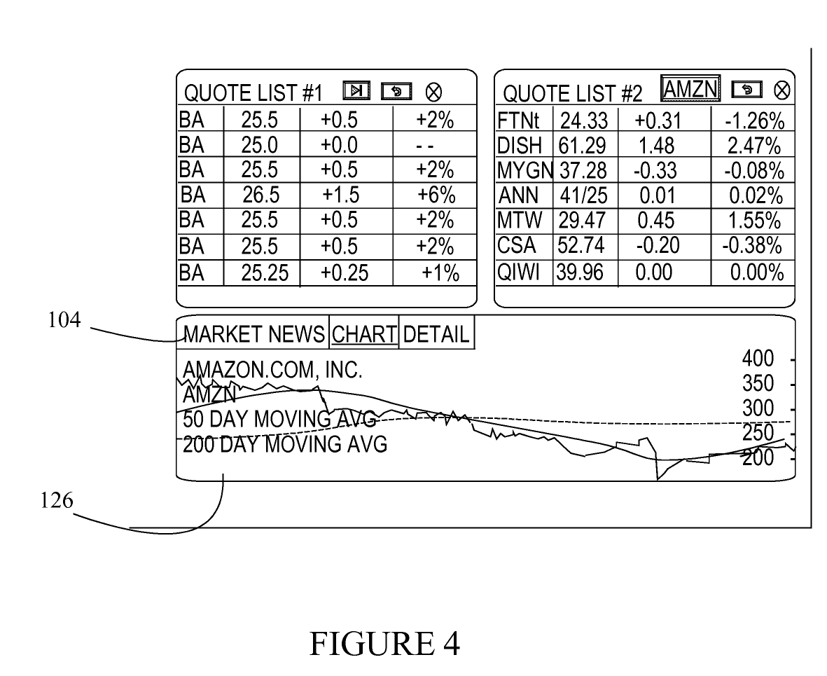

FIG. 1 is a view of a command center/summary page module 112 of the invention, showing position 100, one of a number on a list. Position 100 is in financial product BA (Boeing stock), and is a covered call (cc). The status may be seen with an icon, which will be explained further in reference to FIG. 2. Financial product 102 may be a stock but it may also be any other financial product sold in an options market 104 (See FIG. 4). Note that the market 104 may be online, or the market may be brick-and-mortar with orders sent in and handled manually. The trades may in fact result in paper documents of ownership of options or underlying commodities (stocks) physically changing hands.

Expiry date (date for action) 106 may be seen to be provided, in this case in relative terms: 3 days, 44 days, etc., however, the date may be provided in another format such as “September 29^{th}” or “Monday”, etc.

Ex Div date 108 is also provided, as are earnings, a menu for displaying other modules of the unified system of the invention, side bar tools and so on.

Position type 110 indicates to the user exactly what type of option arrangement they hold the position with. Since there is an enormous variety of such types, a partial listing includes call, put, call spread, put spread, married put, collars, covered calls, puts, synthetic covered calls, naked calls, naked puts, straddle, strangle, calendar, diagonal, butterfly, iron butterfly, condor, iron condor, combo, futures options, futures spreads, futures option spreads, fence, barrier options, American option, Asian option, Bermudan option, Boston option, Canary option, European option, Israeli option, Russian option, Verde option, Parisian option, capped-style option, compound option, shout option, double option, swing option, exotic option, cross option, quanto option, exchange option, basket option, rainbow option, low exchange price option, lookback option, binary option, chooser option, forward start option, cliquet option and combinations thereof, which include the most garden variety of puts and calls and also numerous exotic types of trades, and yet is not a complete listing but merely exemplary, as any type of option trading may be used with the device of the invention.

FIG. 2 is a view of a help function displaying a unified iconography of position statuses of the invention. Icon 130 represents a specific situation in a particular option. In the case of icon 130, it indicates that the current strike price is below the original strike price and the breakeven point has suffered as well.

Unified iconography 132 is seen to encompass a number of likely situations, and referring to FIG. 1 briefly, the system may be seen in operation. It will be appreciated that these simple symbols instantly convey to a user which positions are of interest and which are of less interest, which are in good shape and which are in negative circumstances. What makes this system unique among known option trading packages is that these symbols are themselves consist and are used consistently throughout the package: the term “unified iconography” is used to describe this fact.

Help module 134 may also be seen. While this particular diction function is more of a “help” function, the diction module 134 may also display position definitions, market standards and rules, financial definitions and so on and so forth.

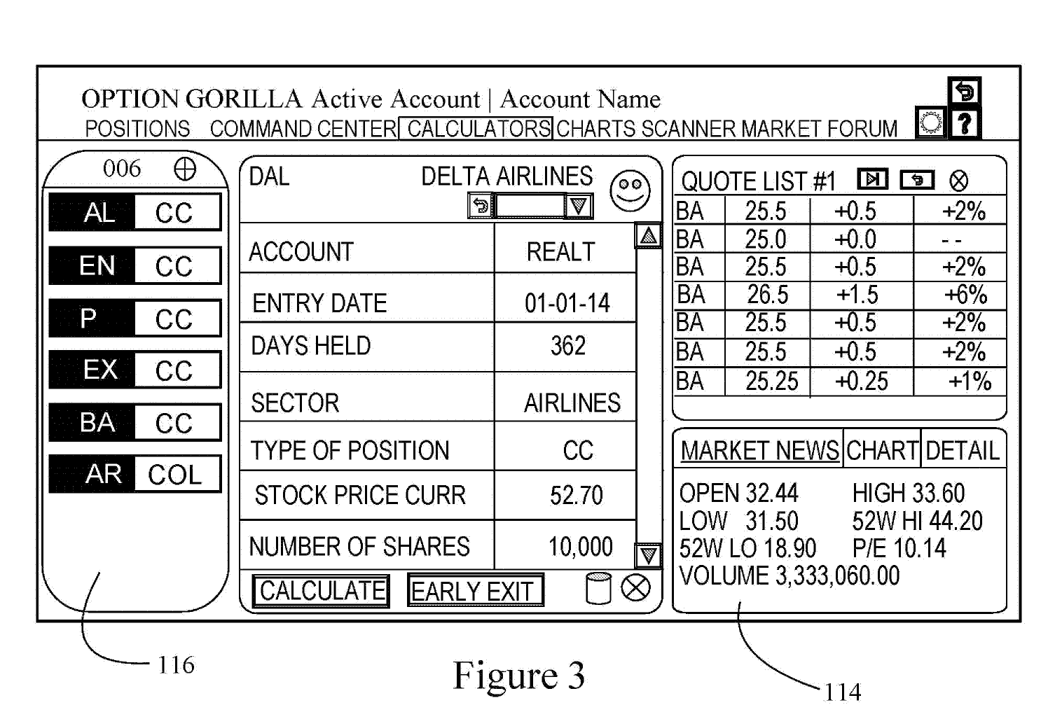

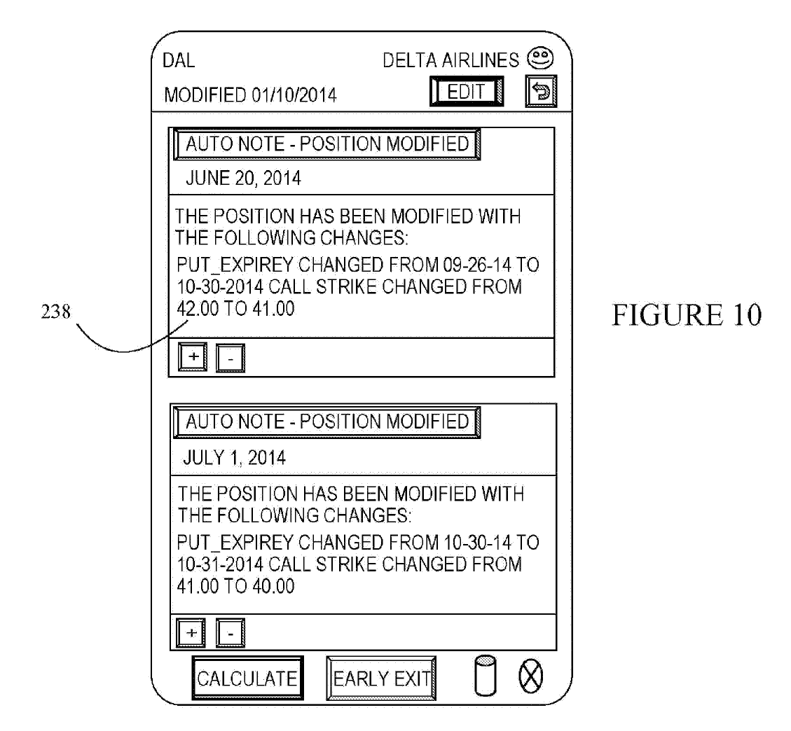

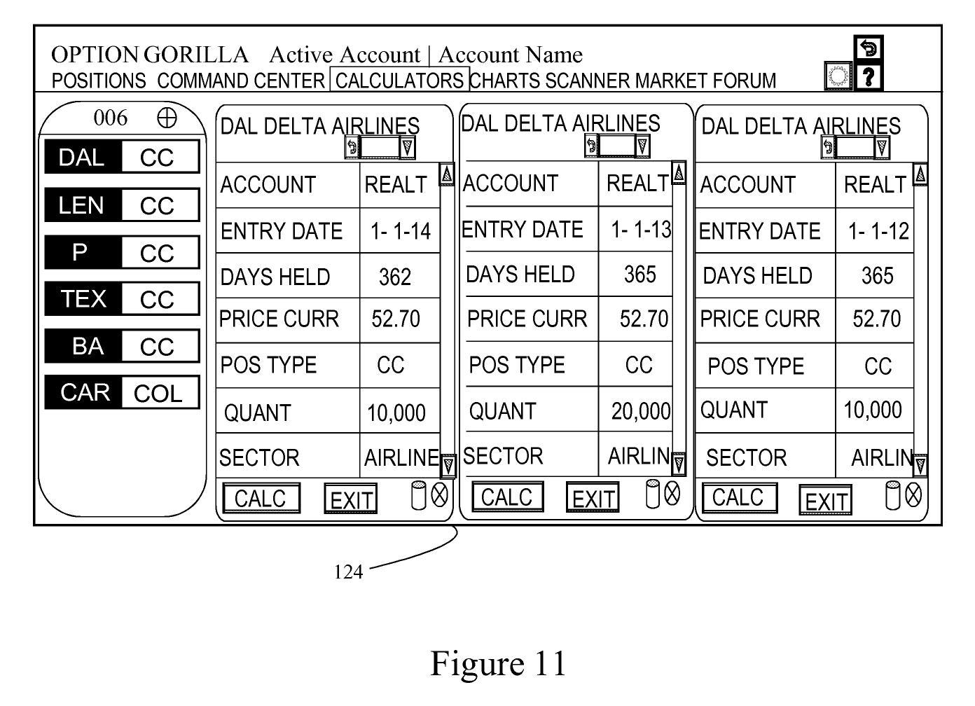

FIG. 3 is a view of a calculator module and display of the invention in the edit mode. In this mode the calculator module instance 114 in edit mode/larger mode provides the display of more information than when the calculator instance is displayed in a smaller mode discussed more in reference to later figures. For comparison, the smaller mode 122/124 may be seen in FIGS. 11 and 12. The larger mode is most convenient when the user is interested only in the specific product (In this case, the BA (Boeing Company) product seen earlier in FIG. 1), rather than in comparing the product.

Of particular interest to the system of the invention is the calculator module instance type 116, in this case, a covered call. The calculator, as discussed earlier, can take many forms depending on the exact option type it is displaying. Thus the calculator displayed for a closed collar might be substantially different than the calculator displayed for a married put or an iron butterfly option. The calculator module is in effect a calculator instance creator: it spawns clone calculators when the user indicates a position should be displayed, or even that a potential position found by the option scanner module should be investigated. Then the calculator, while creating (spawning) the calculator instance, will automatically assign the correct type based on the option of interest. For example, a user might have employed the option scanner to display an option chain of potential options to invest in. The user might click upon one such option, and the calculator module will create an instance of the calculator for display. The calculator module will use the type of the position (for example, a collar) to automatically assign to the calculator instance it creates the same type (calculator type: collar).

The edit mode of the calculator is a useful point to display one extremely useful feature of the calculator, the ability to “play with the numbers.” Unlike a static display, the calculator is dynamic and allows the user to input numbers for alternative scenarios and the using the “calculate” function explore exactly what the results are. For example, a user might alter the stock purchase price and the stock commissions entries on the calculator, then hit the “calculate” button and the calculator might provide different answer for other variables such as profit if the option were exercised immediately or if the position was to be entered using a different set of parameters. The calculator also warns the user when the calculations exceed the users pre-established trading parameters, for example when the user makes a trade which exceeds portfolio allocation, or exceeds number of positions per sector, etc. These parameters are set in the bridge section of the invention.

FIG. 4 is a view of the quote lists, scanning module and graphing capability of the calculator module of the invention, in the large display mode. Scanner module display 126 has a pair of extensive quote lists but also has information about the market 104, in this case, a a 200 day track of a particular financial product, perhaps a stock price for Amazon.com, Inc.®. Thus the lists show that the product is selling at 324.20, down −2.80. The graph shows the shape of the decreases over a longer period of time along with other information.

The device of the invention has a pair of scanning modules which are programmable, however. The more general scanner is the market scanner, the very specific option related scanner is the option scanner, and these two are significantly different. The option scanner scans the market for detailed financial information relating to options the user may be interested in taking. On the other hand, the market scanner provides the user with a programmable module which scans the market for desired information of a more general nature, not specific to options. Thus, the user is not restricted to merely inputting a given financial product, such as a stock price, and then monitoring that. In fact, using the option scanner the user may choose selectable market parameters for the option scanner to search for, and then have it return such options (potential positions) according to whether the financial product meets the parameters. These parameters do include stock price, but also include ROI, down side protection, in-the-money or out-of-the-money options, expiration date, comparisons to moving averages, corporation market cap, corporation earnings, corporation PE ratio, corporation owners, corporation debt, corporation nationality, and combinations thereof.

In addition the scanner scans not just for particular products such as one stock, but for particular strategies considering factors inherent to each particular strategy as they apply to the mind of the people trading them. For example it may scan for a combination of a Put and a Call in the right order and right action (short call, long put) in the case of a collar position and it may present the pertinent numbers that reflect the effectiveness of the strategy (return, risk, etc) These results relate to the calculator instances and return the results that can be automatically exported to the calculator for further manipulation or trade placement. The scanner returns options through the calculator instances into a format that addresses the specificity and idiosyncrasies of the trader in a direct manner with the utmost accuracy and maximum flexibility for semi automatic manipulation (number alteration until desired parameters are met based on original scanner result).

The scanner may have multiple embodiments (ie there may be a scanner for each particular strategy) that will solve different problems e.g. collars, covered calls, synthetic calls, naked puts, naked calls, etc: this is because each strategy presents a mathematical problem that needs to be solved for “X”, X being the desired outcome (return, risk). The scanner solves the problem, the calculator instances allow the user to track the result and also allow the user to further manipulate the problem once X has been established, in order to enhance the value of X or mitigate losses to the value of X should circumstances change negatively.

Interestingly, in regard to graphing of the user's own portfolio, rather than stock histories or the like, even elementary graph functions have been rudimentary in known stock option management software packages as they pertain to a trader's individual strategies. Thus the ability to simply display data graphically as it relates to a particular strategy, which might seem obvious, may be new in the actual field of the invention. Pie charts, line graphs, bar graphs and so on may be used in the invention, and these may in fact be seen in the sidebar tools of FIG. 1 and other figures.

Another ability offered by the device and system of the present invention is the ability of a user to have multiple accounts. A single individual may wish to maintain multiple trading accounts, the present invention allows this, and offers the ability to switch between those accounts without logging out, for example, switching between an IRA (tax advantaged trading account) and a regular account, or between a trust fund account held for the benefit of a child (managed by the parent) and an account owned by the parent them self.

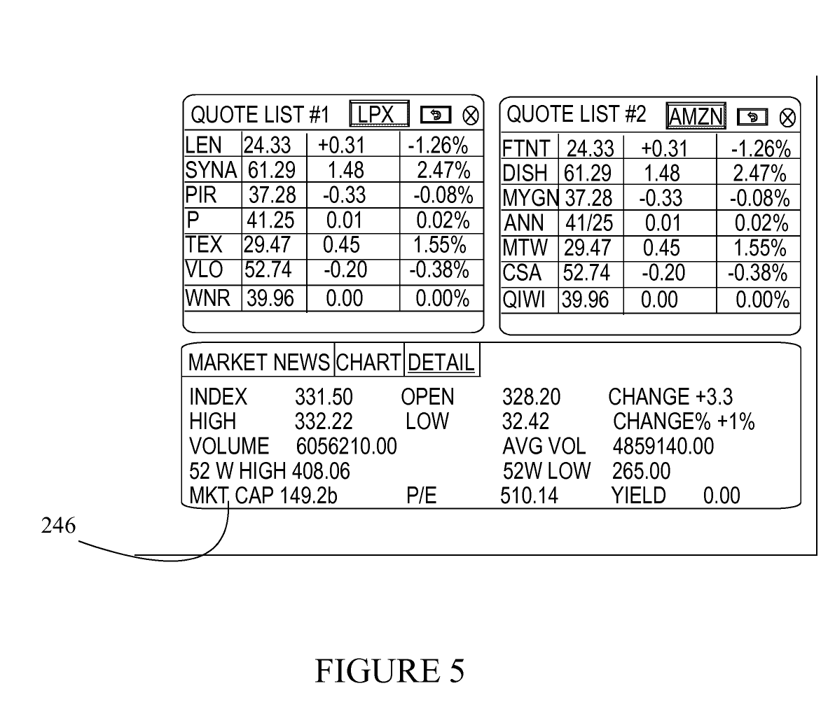

FIG. 5 is a view of an alternative embodiment of the market scanning module of the invention. Market scanning module 246 may be seen to still be in quote list mode of the active calculator display, but now instead of a chart of a single financial product it is used to display a summary of market data which the scanner derived from the market.

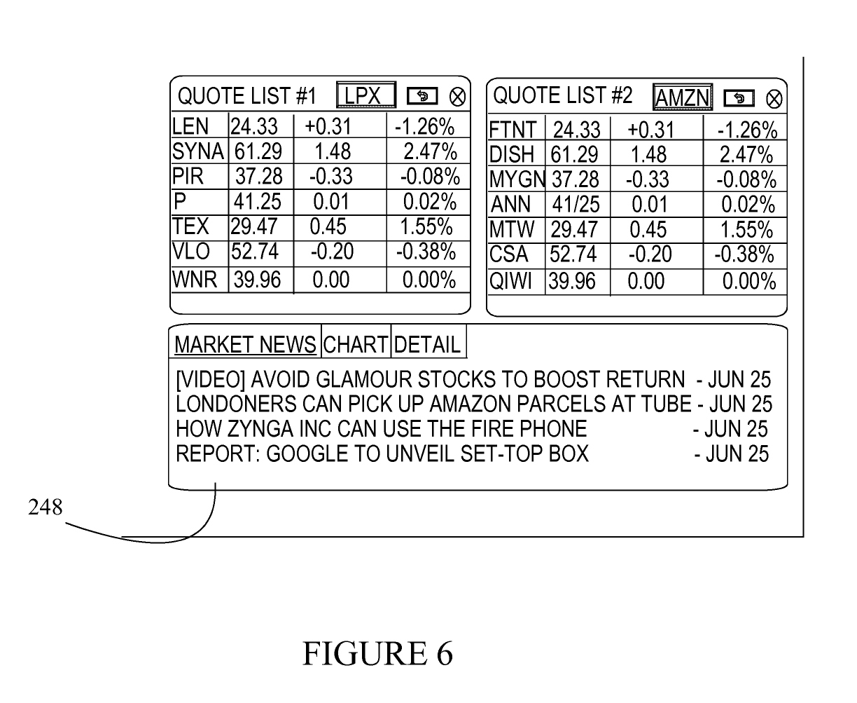

FIG. 6 is a view of another alternative embodiment of the market scanning module of the invention. Market scanning module 248 in this case is displaying one or more news article located from the market 104. These may be presented as scrolling headlines as shown or in other equivalent manners.

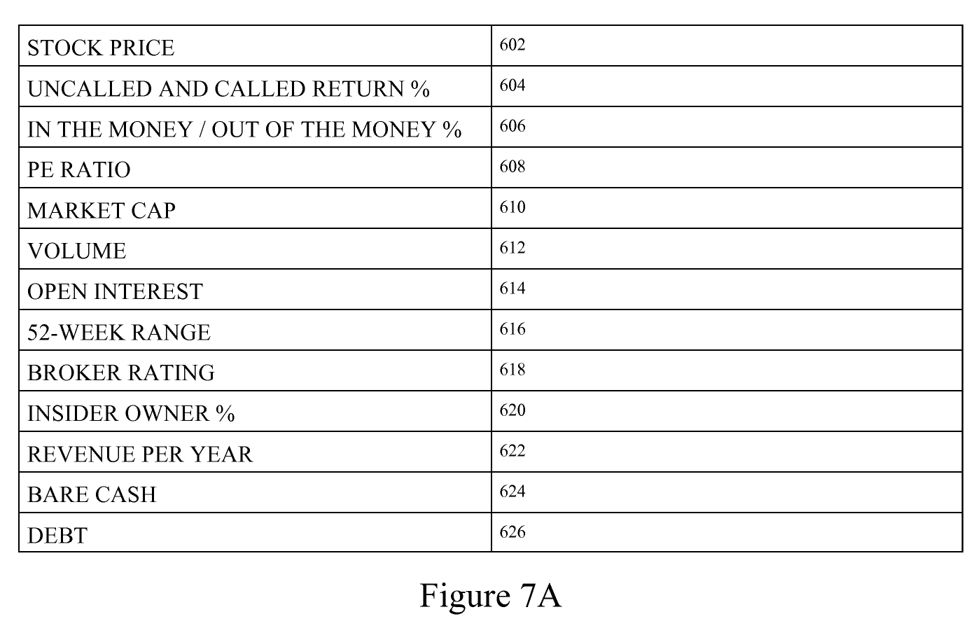

FIGS. 7A and 7B are a of an exemplary data structure showing searchable fields which may be used by the option scanner function user when laying out a search for potential investment opportunities. Unlike the market scanner, the option scanner searches for very specific parameters as they pertain to stocks, options, etc., which the user may be interested in, for example, as potential investments. The list of items which may be searched is quite extensive, as users may have quite detailed criteria by which they wish to filter the universe of potential investments available on a larger market.

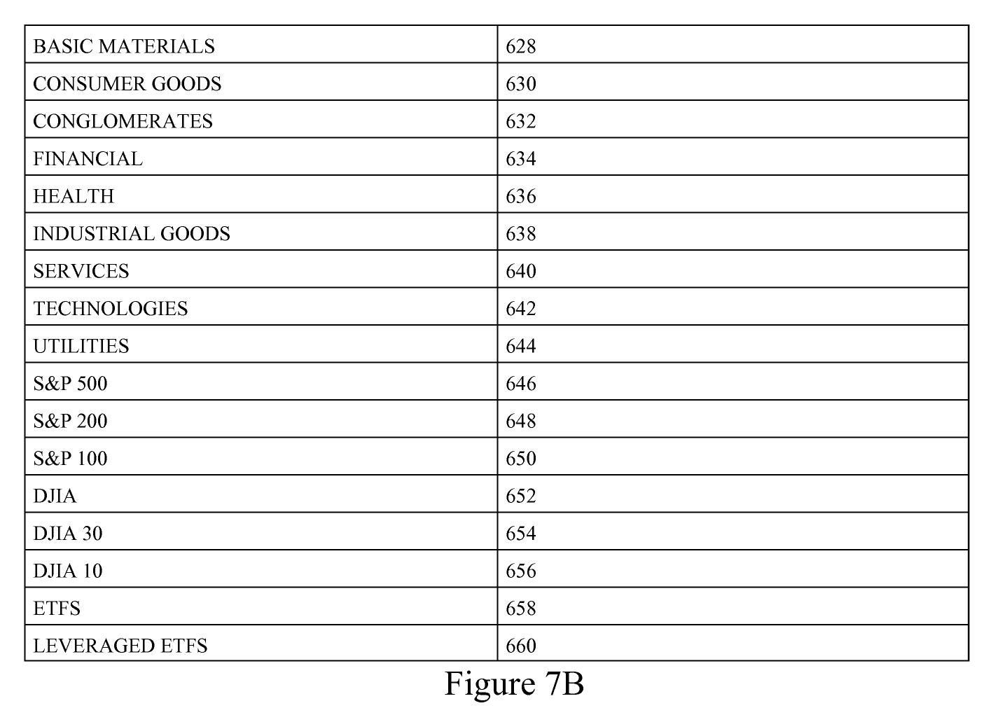

FIG. 8 is a view of a calculator module of the invention in option chain mode, along with a displayed option chain 242. Option chain 242 is an extremely useful analytical tool which displays a string of options costs at various strike prices. However, the positions are related in that they all relate to a single financial product, and the prices of each are shown. The option chain is current market data that allows the user to plan his strategy for a new position based on the cost of the options related to a particular stock. This option chain is interactive allowing the user to click the desired price, once this is done the relevant information is populated in the calculator. This is done for speed, convenience and to avoid manual data input mistakes. Having this functionality reduces the time it takes to ‘play around’ with number to less than half. By means of the option scanner (not the more general market scanner), or the option chain, the user may quickly compare options available for investment and in alternative embodiments, might even click on one or more to instantly populate a calculator instance for each one, then compare the options side by side.

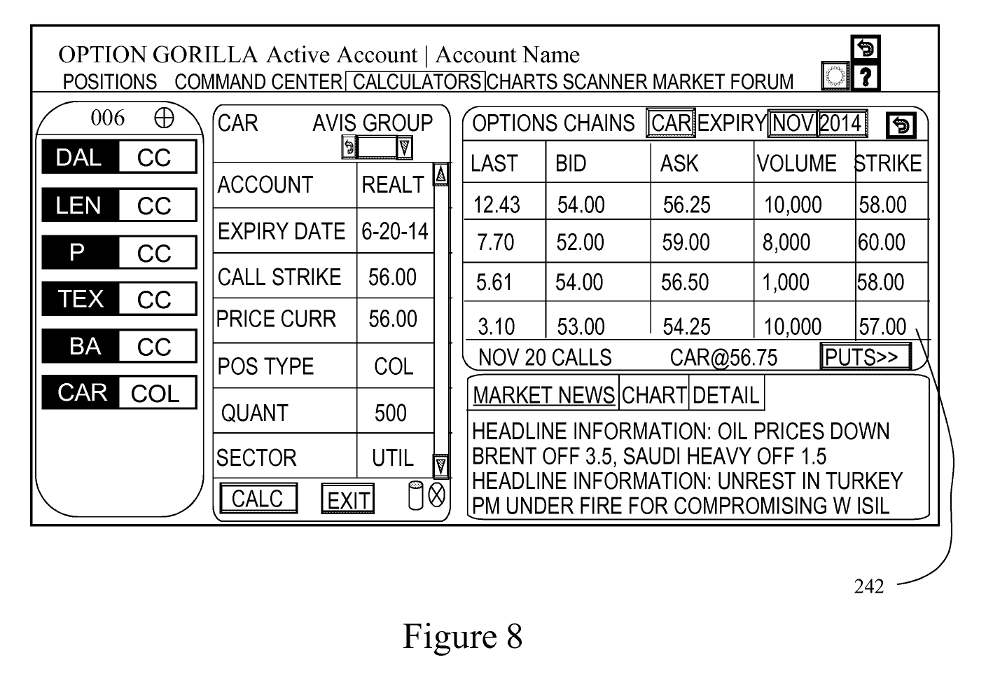

FIG. 9 is a close up view of some of the functionality of the calculator module of the invention. Calculate function 252 may be invoked after entry of alternative numbers, to require the calculator instance to run the numbers so that a user can see the results the changes they have entered. Early exit function 254 allows one extremely common computation to be performed at the push of a button: calculating the financial outcome of an early exit from a given position in a financial product. Delete function 256 obviously deletes the calculator instance and the data associated therewith, while close function 258, rather than closing the calculator closes the position. The “close” module 258 is an important part of the system of the invention as the close function transfers the open position which is being closed to a closed position which is retained in the database of closed positions.

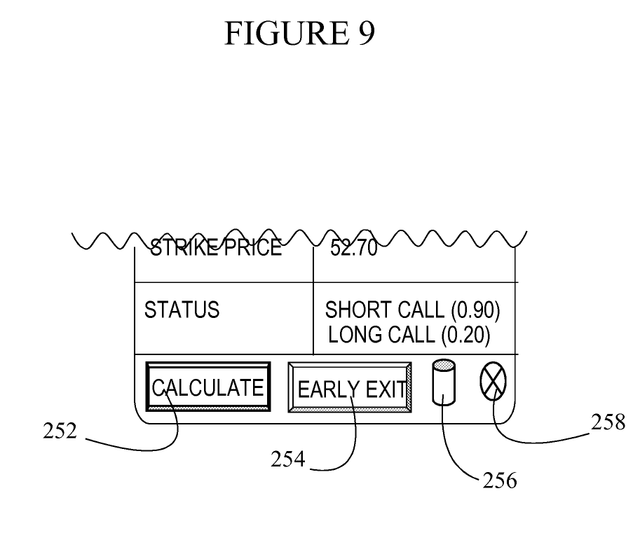

FIG. 10 is a view of an auto note module of the invention, showing the prompt to make notes on why position changes have been made, thus enhancing the effectiveness of retaining all changes made to any positions. Editable notes field 238 is brought up automatically when a user invokes the close function 258 and then makes automatic basic notes about the change, and may also prompt the user to make notes for themselves as to why the change was made, the results and any other data the user may wish to manually enter.

Editable notes field 238 is in fact not only accessible through the close module 258, it may also be invoked in other ways, for example, by the user of the system in the calculator mode, summary module, bridge module and so on and so forth.

FIG. 11 is a view of an open positions display of the invention. Position overview module, open, 124, shows several open positions.

It will immediately be seen that in contrast to static displays, the open positions are being shown inside the “small” display mode of the calculator. The small display mode of the calculator module (or more accurately, multiple instances thereof) is specifically designed to be small enough to allow more than one to be displayed side by side. In this view, the user can now compare different positions in different products against one another. Thus this is a display function which adds immensely to the effective knowledge and analytical abilities of the user.

Beyond that, the active calculators of the invention allow immediate, side-by-side “playing with the numbers” for entirely unrelated products. Needless to say, the products are related in one way: the user is interested in comparing them, even if no one else in the world has the same combination of positions and no other relationship exists.

In addition, the user is not limited to a predefined choice or arrangement of the calculators. Thus, “Lennar” may be seen at the left side of the FIG. 11, not within the calculator display area. However, should the user decide to compare a Lennar® position with the Delta Airlines® positions, the calculators can be clicked and dragged until the two are side-by-side.

FIG. 12 is a view of a closed positions display of the invention. Calculator instance, smaller mode, 118 and calculator instance, smaller mode, 120 are seen side-by-side. Position overview module, closed, 122, thus allows the same sorts of comparisons for closed positions as for open positions. And by use of the option chains or other displays, closed positions can even be compared to open positions. In this page positions can also be located by ticker symbol using the search tool.

FIG. 12 also shows the closed positions page of the invention with a chronological index 250 of closed positions. The use of the index allows another easy method for a user to get into their closed positions. Note that the “history chain” allows entry as well, so there are multiple methods of reaching any position, not just closed positions, but open positions

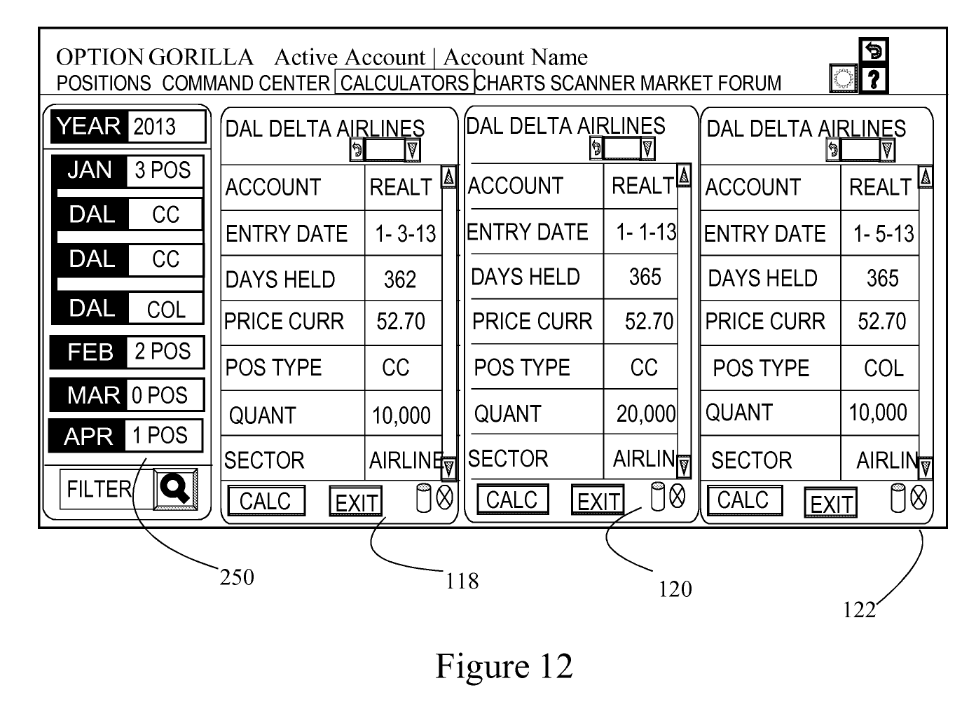

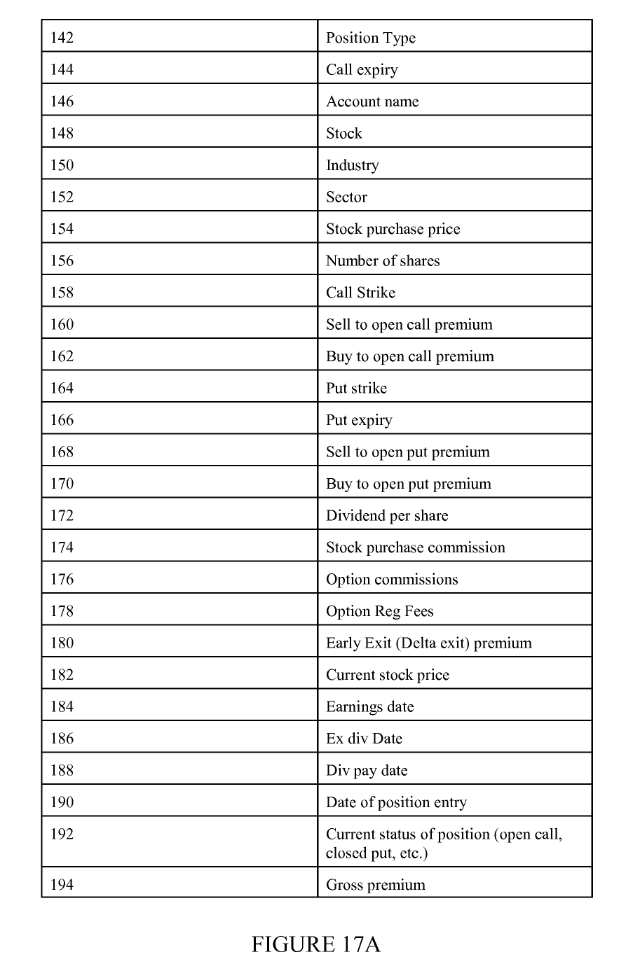

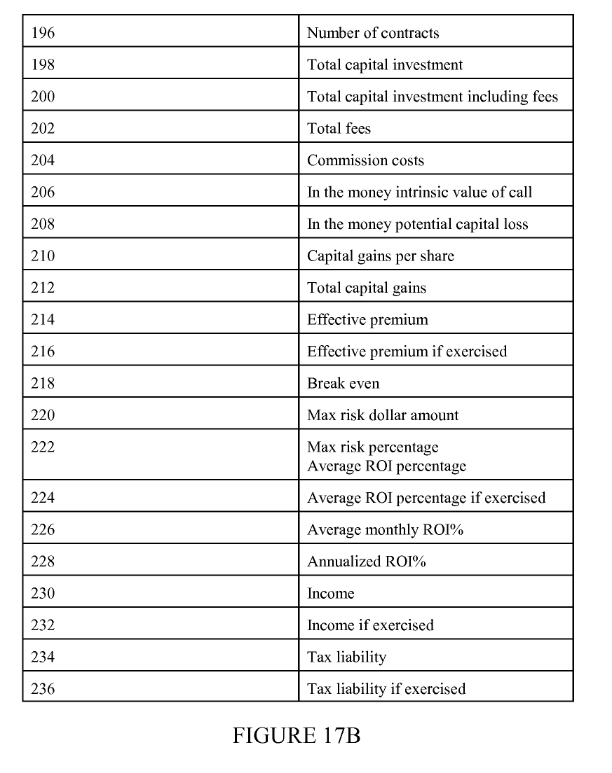

FIG. 13 is a view of one possible, simplified view of a bridge page. Bridge module 128 has a wider range of data and information available within it than other displays. This particular embodiment is a very short one for a bridge module: a bridge module might have and display all, or almost all, of the data fields presented in FIGS. 17A and 17B, discussed later. In general, the bridge module is a super command center for the user, and is able to display either a global overview of all positions of a user, all profits, tax liabilities, etc., or on the other hand may be considered to be able to display, in detail, any data field associated with any position, such as the data fields shown in FIGS. 17A, 17B, the data fields shown by the large mode of the calculator, etc.

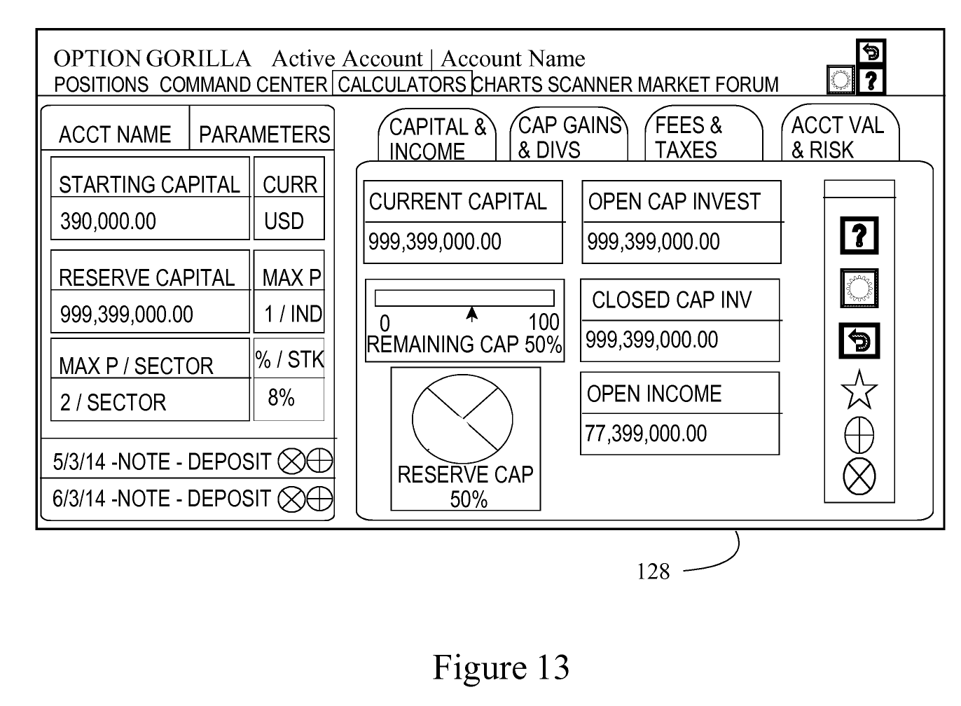

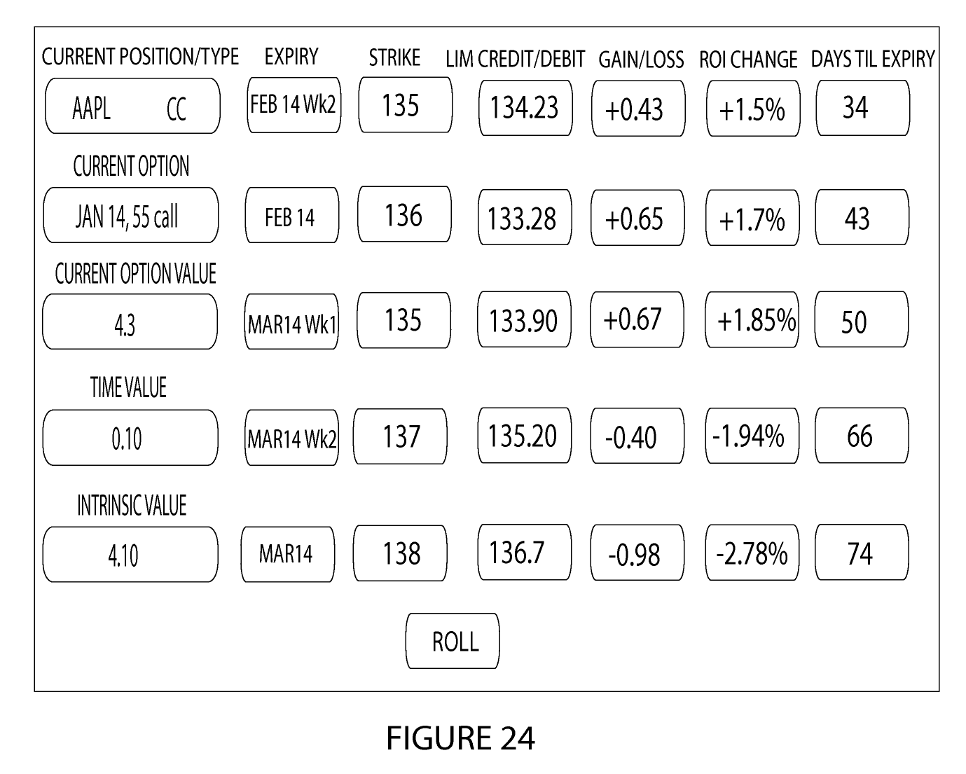

FIG. 14 is a view of a compounding calculator module of the invention also termed “schedule mode”, showing tax liabilities and the like. This calculator module/display (which is preferably embodied as an entirely separate calculator function divorced from the other calculator modules) calculates for the user and then displays the financial results over time of a given investment: in the example shown in calculator 240, a principle of 100,000 has been invested for 20 years, with a monthly withdrawal of 1000 units. The calculator displays to the user the balance each month of year 7, and index of years of the investment, tax liability by year and so on. The user is once again empowered to examine the numbers in a logical, ordered way and alter the numbers to check out differing scenarios. It is also possible to have an additional calculator module/fourth calculator mode, which serves a prediction function. The predictor calculator may be used to model normal expectations of an option's price given assumptions provided by the user. Thus a user might ask the predictor module to estimate the value of an option on a stock, presently 2$ in price, if that price rises to 5$. This calculator mode may also be used to spawn another type called the scenario tool, discussed below in relation to FIG. 24. The scenario tool, once the numbers have been entered (which may be by the user, or it may be autopopulated throughout the unified option trading system of the invention) will give the user all available choices for the roll, based on what is currently available on the market, along with a profit or loss analysis for each one and their corresponding time frame. The scenario tool will also inform the user as to how each possible transaction will affect the rate of return of the position in relation to its original state, including taking into account the time frame selected for each individual possibility.

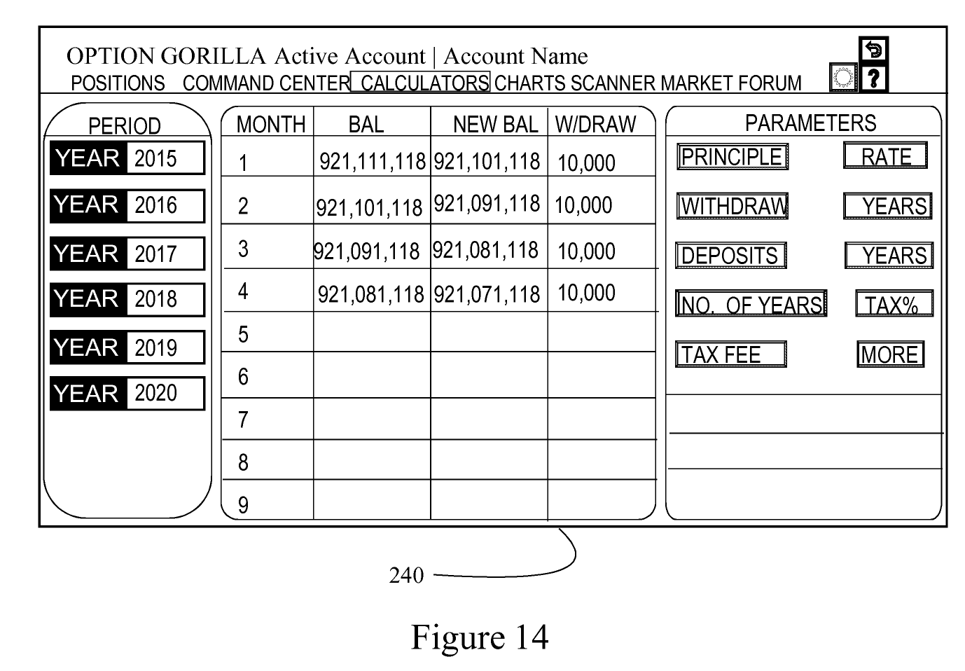

FIG. 15 is a view of a reminder/alert message of the invention, showing active links directly to positions of interest. Thus, a user may set the system of the invention to alert them according to parameters set by the user in the settings page, or by other modules, and the alerts may indicate that action is required or merely possible. In particular, action dates such as action dates 106 (FIG. 1) may trigger an alert message regardless of market conditions.

Active message 136 may be seen to have a list of links 138 to particular positions. These active links allow the receiver of the active alert message 136 to immediately go to that position, for example on a mobile device app embodiment of the invention. This in turn means that a user does not need to enter the main page of the system, locate the position of interest manually and then finally be able to display it and examine it.

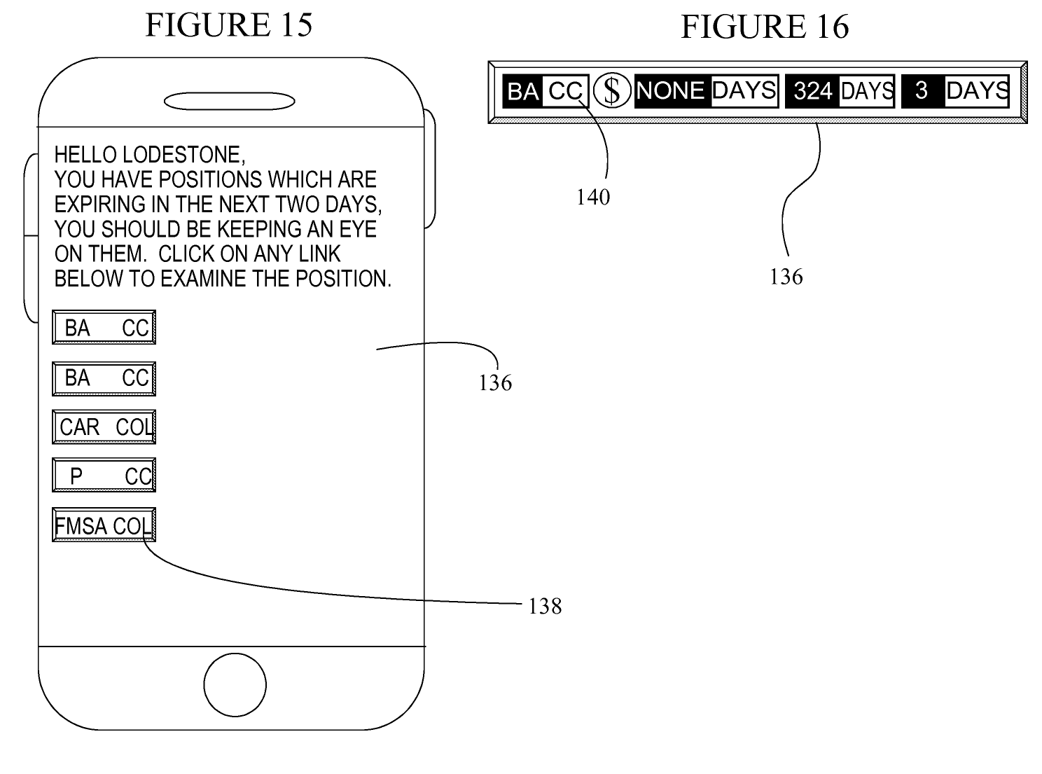

FIG. 16 is a view of a view of an alternative embodiment of a reminder/alert message of the invention. Alternative message with link to particular position 140 is more dressed up: in this alternative format the list of links is augmented with the status symbol, the action date (5 days) and so on.

FIG. 17a is a view of part of an exemplary data structure for a position within the database of the invention. FIG. 17b is a view of the remainder part of the data structure for a position within the database of the invention.

Position type data field 142, well down the list, is of particular importance as this field, which may be a flag, a text string, numerical or whatever object is most effective, indicates to the calculator module which spawns calculator instances the type of calculator instance to spawn.

Expiry date data field is of high importance as it is used for alerting the user, for example by causing the sending of messages such as shown in FIGS. 15 and 16.

Account name 146 and stock 148, as well as industry 150 and sector 152 are all data fields for the user's analysis, and may well contain non-numerical data in embodiments. In addition, it will be noted that the example data structure shown lacks the editable notes field 238. Different embodiments of the data structure may thus have different data fields within them.

In addition, the absence of the notes field 238 may be because the data structure is itself an active structure which is added to as needed. Thus, the user may not have made any editable notes and thus the field 238 may not be necessary and thus has not been added to the structure. The object template however may contain the coding for the structure allowing creation when a user or a module prompts for the creation of notes.

In addition to active notes, most of the specific data fields of the invention may be added by the system of the invention actively, as needed. Thus, numerous types of option trades involve more than a single type of product. In such cases, most of the data structure might be replicated, once for each product. Numerous other data structure alterations may be made: some options will not have one or the other of put strike 164 versus call strike 158 and space in the non-volatile memory of a computer processor unit, on which the system of the invention may be stored, may be saved by not instantiating these until required.

On the other hand, a wide range of actual financial numerical data is present in the data structure as well, including, but not limited to, the items shown in the tabular data structure display of FIGS. 17A and 17B: stock purchase price 154, number of shares 156, call strike 158, sell to open call premium 160, buy to open call premium 162, put strike 164, put expiry 166, sell to open put premium 168, buy to open put premium 170, dividend per share 172, stock purchase commission 174, option commissions 176, option Reg Fees 178, early Exit (Delta exit) premium 180, current stock price 182, earnings date 184, ex div Date 186, div pay date 188, date of position entry 190, current status of position (open call, closed put, etc.) 192, gross premium 194, number of contracts 196, total capital investment 198, total capital investment including fees 200, total fees 202, commission costs 204, in the money intrinsic value of call 206, in the money potential capital loss 208, capital gains per share 210, total capital gains 212, effective premium 214, effective premium if exercised 216, breakeven 218, max risk dollar amount 220, max risk percentage/Average ROI percentage 222, average ROI percentage if exercised 224, average monthly ROI % 226, annualized ROI % 228, income 230, income if exercised 232, tax liability 234, and tax liability if exercised 236.

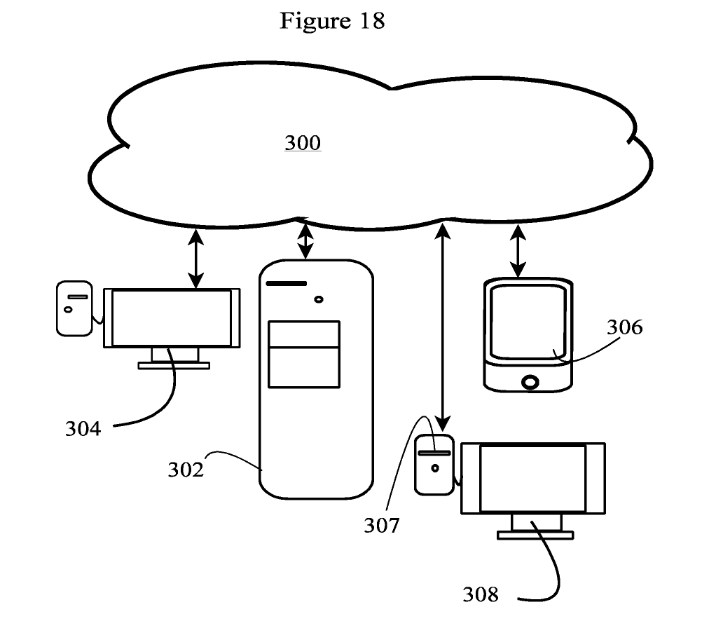

FIG. 18 is a block diagram of a network system showing a market, an option seller, and two devices using the invention: a mobile device and a computer. Electronic network, internet, etc. 300 may be any convenient trading ecosystem. There are dedicated networks for many marketplaces, the internet is frequently used, and so on.

Market for financial products/server 302 is the actual marketplace. Note that while it is depicted as a server computer, in fact the server may be located in a brick-and-mortar exchange (such as the NYSE) or may be entirely online (Bitcoins for example).

Option seller 304 represents an entity, computerized or human, which is offering options on the market. Mobile device/user 306 represents a user who accesses the invention via a mobile device, including but not limited to pads, tablets, smartphones, pods, games, netbooks, and all other mobile devices now known or later devised.

A computer 308 having non-volatile memory 307 with the system stored thereon is seen as an alternative to the mobile device, and at the present time this is a preferred embodiment by comparison. By means of the network 300, the different entities may communicate, and the physical ownership of stocks, stock options, and money may be effected.

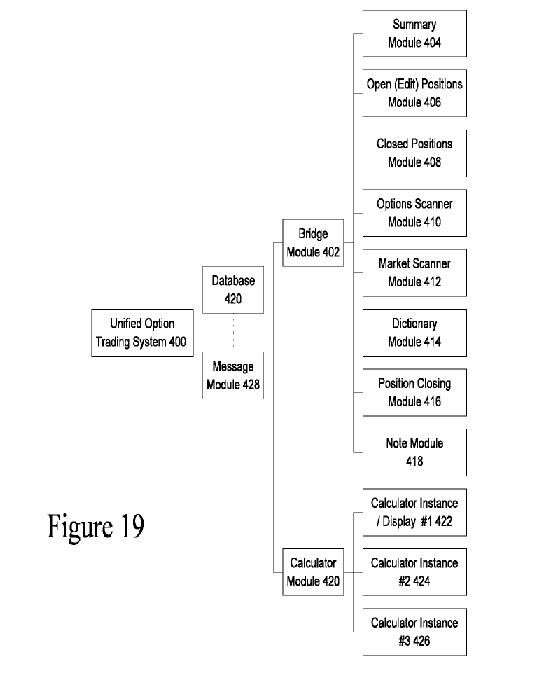

FIG. 19 is a structural diagram of one possible embodiment of the modules of the invention, exemplary only. It will be understood that the unified option trading system 400 of the invention may have many equivalent structures within the scope of the invention.

Bridge module 402, as discussed earlier, may provide a global view of a user's portfolio(s) and account(s), and may show all details contained in database 420.

Summary module 404 provides a shorter view, as shown previously, including the uniform iconography of the option trading system of the invention.

Open positions module 406 allows editing, comparing and viewing of open positions, while closed positions module 408 allows viewing and comparison of closed positions.

Options scanner module 410 is not to be confused with market scanner module 412: the first scans for specific criteria and if it finds an option opportunity which matches, returns this to an option chain as being worth investigation, while the market scanner hunts for more general market data, rather like a ticker.

Help module 414 provides assistance to users by providing explanations of terms, usages and so on.

Position closing module 416 ends an option position, not just transferring stock or money to another person or entity but in addition activating automated note module 418 which makes certain automated entries and allows input of manual ones as well.

Database 420, as discussed earlier in reference to FIG. 17, to the bridge module, etc., contains the complete set of trading data of the user, both historical and present.

Calculator module 421 spawns (creates) 422, 424, 426, calculator instances which may be of various display sizes (larger, more data, or smaller, allowing comparison across positions) and various types (prediction calculators, schedule calculators and position calculators, as discussed previously.

Message module 428, as discussed in reference to FIGS. 15 and 16, may send messages in response to the operation of the scanner module (alerts), the summary module (for dates) or virtually any other module in embodiments.

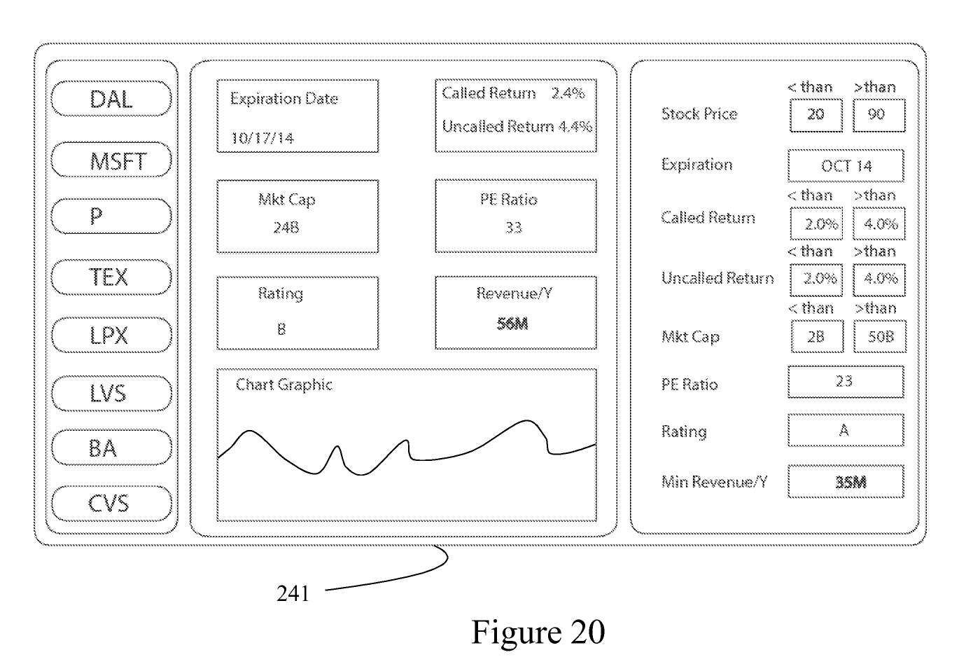

FIG. 20 is a diagram of a scanner module which is used to find a position in the market which matches parameters input by the user. Scanner 241 will accept parameters such as those shown. For example, the scanner might be set to hunt for stock prices greater than 20 or less than 90, with an expiration date of October 14^{th} of the present year. When a matching product is found the user is presented with the information for their examination, after which they can make a decision whether to enter the position or not. The embodiment displayed shows only a few options, however, all of the search parameters shown in FIGS. 7A and 7B may be searched, or searched as excluded ranges (“not prices above 53.5”).

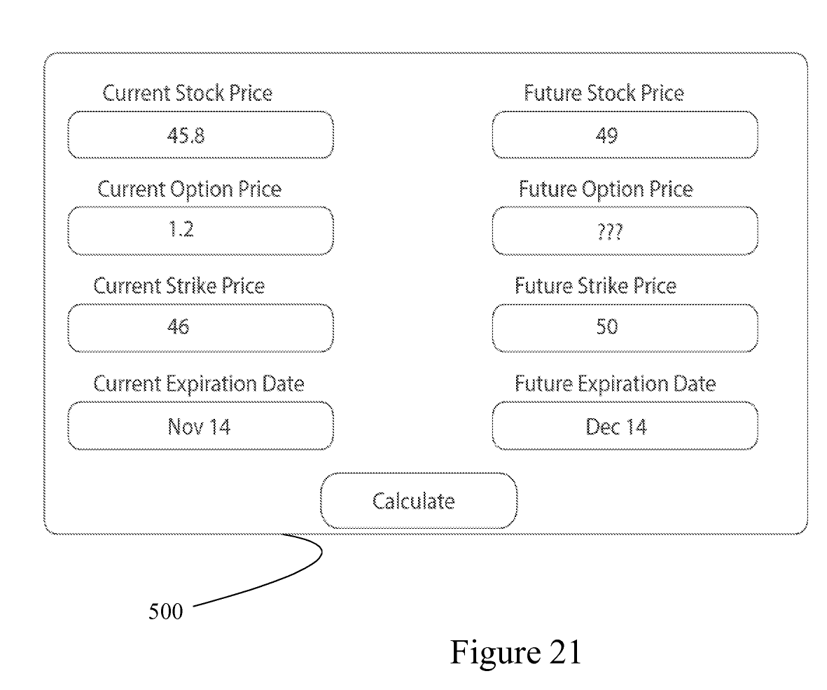

FIG. 21 is a diagram of a predictive calculator 500 which provides to a user a prediction about value or other variables relating to a position based upon variable values entered by the user. Calculator 500 provides the user with various variable fields which may be either queried as output variables or provided to the module as input variables. For example, a user might provide a current stock price of 45.8 and a future stock price of 49 along with other variables, then ask for a future option price. This calculator mode may also be used to spawn another type called the scenario tool, discussed in relation to FIG. 24.

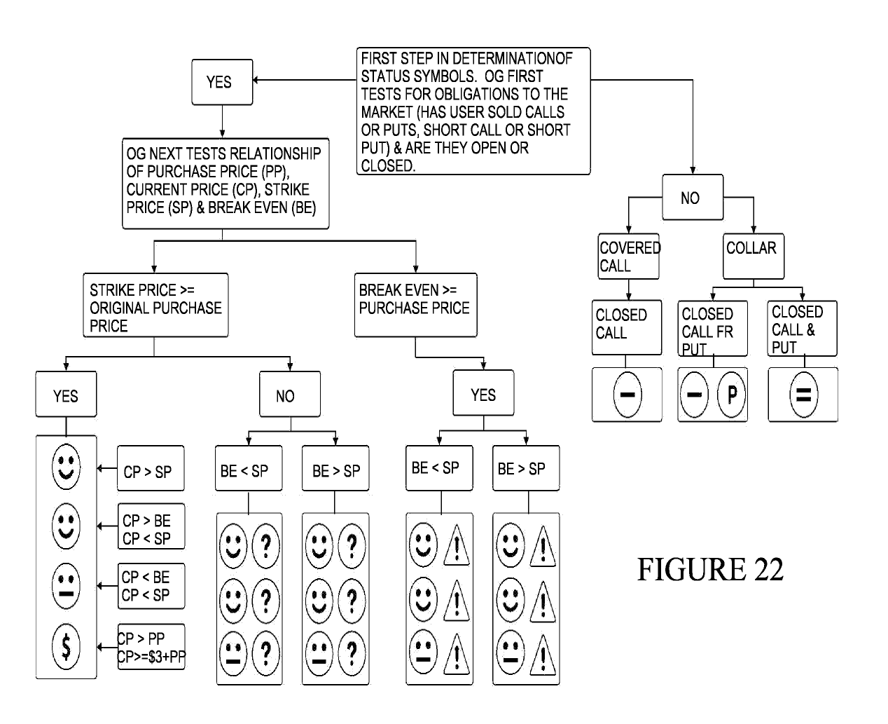

FIG. 22 is a hierarchical diagram showing the logic for presentation of different status markers or status symbols used uniformly throughout the unified trading system of the invention. The diagram (which incorporates certain aspects similar to either a flow chart or a data structure) indicates that the first step is determination of obligations to the market.

The diagram uses certain conventions:

| | |
|---|---|
| PP | Purchase price |
| BE | Break even |
| SP | Strike price |
| CP | Current price |

For those items which meet the requirements of the first test (which is really a compound test depending on circumstances and types of options, etc) the system then initiates a second examination in which it tests for the relationship of prices such as strike price versus original purchase price. For example if the strike price is greater than the original purchase price, and the current price is greater than the strike price, a happy face symbol, or another symbol of good news, may be displayed throughout the system (for example, in the bridge module) in relation to this trade. On the other hand, if the current price is less than the break even and less than the strike price, a less encouraging symbol may be displayed, and so on.

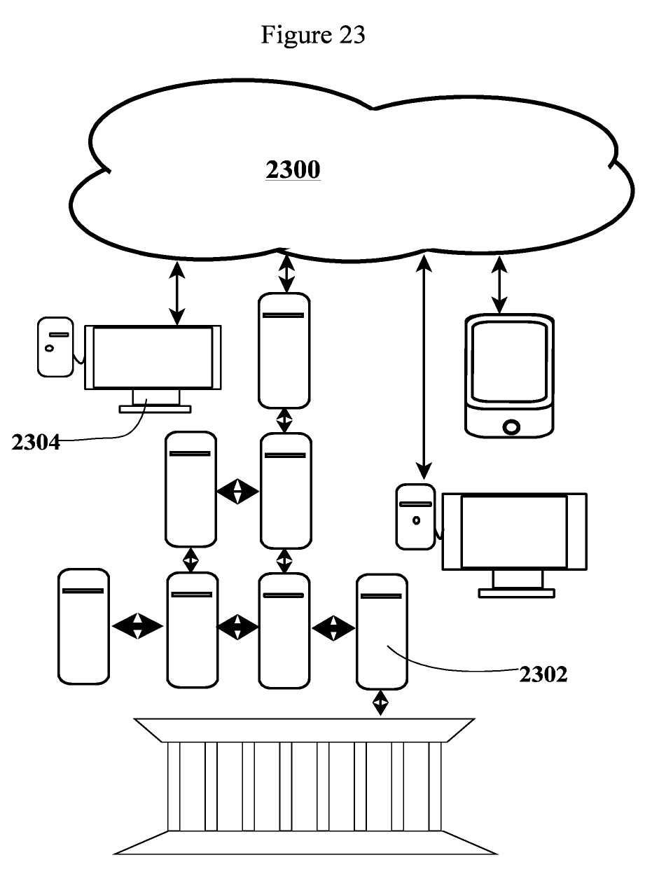

FIG. 23 is a block diagram of another useful aspect of the present invention, the ability to serve as a bridge from a user who wishes to carry out trades in a cryptocurrency to a trading house which uses actual legal tender. User 2304 may be seen to be connected by a wide network 2300 (such as the internet) to a cryptocurrency network 2302, for example, the Bitcoin network.

Thus a user might transact trades/options in Bitcoin itself, if dealing with others who are also interested in this cryptocurrency as an index. In this particular sub-embodiment, the device is in fact functioning as if Bitcoin were a legal currency. Thus options and so on may be priced in Bitcoin and the user will see, in calculators and other displays within the system, a marking of prices in Bitcoins. Note that the real advantage here is not simply using an alternative currency. The actual benefit is that the user is able to tap into the exchange network 2302 which is shown as a distributed network whose nodes carry financial information without any centralized authority such as a credit card network or other financial system.

On the other hand, in alternative embodiments the user may take advantage of the system to serve as a bridge to a more traditional trading house (displayed as a brick-mortor institution but not so limited), which traditional trading house operates in other currencies such as Euro, Yen, Dollars or the like. Then the Bitcoin user may have their trades automatically presented to other parties to the transaction as Dollars or the like while themselves doing accounting in Bitcoins.

FIG. 24 is a screen shot or data structure diagram of a scenario tool module of the invention, which might be considered to be a type of the calculator, or yet another type of calculator. The scenario tool, once the numbers have been entered (which may be by the user, or it may be autopopulated throughout the unified option trading system of the invention) will give the user all available choices for the roll, based on what is currently available on the market, along with a profit or loss analysis for each one and their corresponding time frame. The scenario tool will also inform the user as to how each possible transaction will affect the rate of return of the position in relation to its original state, including taking into account the time frame selected for each individual possibility.

Note that in embodiments, the exact type of transaction, for example, a covered call versus a collar, might be examined for closed transactions. The various outcomes, tests and trading options and trading circumstance shown throughout this chart are of course merely exemplary and might be altered within the scope of the invention. For example, a user might set a threshold level of current price being greater than purchase price plus a predefined amount such as 3$ for one test, and so on.

Throughout this application, various publications, patents, and/or patent applications are referenced in order to more fully describe the state of the art to which this invention pertains. The disclosures of these publications, patents, and/or patent applications are herein incorporated by reference in their entireties, and for the subject matter for which they are specifically referenced in the same or a prior sentence, to the same extent as if each independent publication, patent, and/or patent application was specifically and individually indicated to be incorporated by reference.

Methods and components are described herein. However, methods and components similar or equivalent to those described herein can be also used to obtain variations of the present invention. The materials, articles, components, methods, and examples are illustrative only and not intended to be limiting.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

Having illustrated and described the principles of the invention in exemplary embodiments, it should be apparent to those skilled in the art that the described examples are illustrative embodiments and can be modified in arrangement and detail without departing from such principles. Techniques from any of the examples can be incorporated into one or more of any of the other examples. It is intended that the specification and examples be considered as exemplary only, with a true scope and spirit of the invention being indicated by the following claims.

What is claimed is:

1. A unified option trading system, for use in managing a portfolio having a plurality of positions in a plurality of financial products in at least a first market, each of the positions in turn having dates for action associated therewith and a position type associated therewith, the unified option trading system comprising:
a summary module, the summary module operative to track each of such positions and each of such dates and furthermore to display each of such positions and each of such dates;
a calculator module operative to spawn a plurality of calculator module instances;
a plurality of calculator module instance types, each calculator module instance type being selected from the group consisting of: call, put, call spread, put spread, married put, collars, covered calls, puts, synthetic covered calls, naked calls, naked puts, straddle, strangle, calendar, diagonal, butterfly, iron butterfly, condor, iron condor, combo, futures options, futures spreads, futures option spreads, fence, barrier options, American option, Asian option, Bermudan option, Boston option, Canary option, European option, Israeli option, Russian option, Verde option, Parisian option, capped-style option, compound option, shout option, double option, swing option, exotic option, cross option, quanto option, exchange option, basket option, rainbow option, low exchange price option, lookback option, binary option, chooser option, forward start option, cliquet option and combinations thereof;
a plurality of calculator module instance data structure types, each calculator module instance data structure type being associated with one calculator module instance type;
first and second calculator instances spawned by the calculator module, each calculator instance having one calculator instance module type and one calculator module instance data structure, and displaying respective first and second of such positions, the calculator module when spawning the calculator instances automatically assigning the appropriate calculator instance module type thereto based upon such position types associated with such positions;
each calculator instance having two display modes, a smaller display mode and a larger display mode, and displaying in the larger mode stock purchase price, number of shares, call strike, call expiry, put strike, put expiry, dividend, stock commissions, options commissions, regulatory fees, stock current price, earnings date, ex dividend date, position type, date of entry, status, gross premium, days held, number of options contracts, total capital investment, total capital investment with fees, total fees, in the money intrinsic value, in the money loss, capital gains per share, total capital gains, effective premium, effective premium if exercised, breakeven maximum risk dollar amount, maximum risk percentage, ROI percentage, ROI if exercised, average monthly ROI, annualized ROI, income, income if exercised, tax liability, tax liability if exercised, current breakeven price, current strike price, and original strike price;
a position overview module having the first and second calculator instances displayed therein, side by side, thus allowing easy comparison between such first and second positions;
an open positions editing module displaying a third such position which is open, such third position being in a third financial product, and furthermore displaying an option chain of such positions, associated with such third financial product, the open positions editing module further operative to allow changes to such third position, in particular, each of such positions in the option chain being an active link operative when selected to activate the calculator module and spawn a new calculator instance automatically populated with data from such selected position;
a closed positions module retaining and displaying a fourth such position which is closed, such fourth position being in a fourth financial product, and furthermore displaying a history chain of such closed positions associated with such fourth financial product, the closed positions having active links to one another, the closed positions module further displaying a chronological index linked to such positions;
a market scanner module operative to search such first market by means of an electronic network according to a first set of selectable parameters and to return any market data which matches the first set of parameters and to update the unified option trading system;
an option scanner module operative to search such first market by means of an electronic network according to a second set of selectable parameters and to return any additional such options available on such first market which match the second set of parameters and to update the option chain with such additional options;
a bridge module operative to calculate and display at least one member selected from the group consisting of: reserve capital, starting capital, percent stock, currency of display, max permissible positions per sector, max permissible positions per industry, deposited funds, withdrawn funds, open income, closed income, open capital investment, closed capital investment, current capital, remaining capital, starting account value, current account value, account tax open positions, account tax closed positions, account tax open and closed positions, average risk per position expressed as an amount of currency, average risk per position expressed as a percentage of position value, total risk expressed in currency, total fees open positions, total fees closed positions, total fees open and closed positions, total capital gains open positions, total capital gains closed positions, total capital gains open and closed positions, open positions associated with this account, closed positions associated with this account and combinations thereof;
wherein the various modules can access data from other modules and are operative to populate one another;
and further comprising a unified iconography and a unified abbreviation system used by all modules of the unified option trading system;
and further wherein the unified option trading system of the invention is not a spreadsheet.

2. The option trading system of claim 1, further comprising:
a first data field associated with each position, the first data field containing therein an indicator of a first date; wherein the first date is one member selected from the group consisting of: such dates for action, an expiry date, an option date, ex-dividend date, earnings date, date of position entry, length of time position has been open, date position closed, dividend pay date, and combinations thereof.

3. The option trading system of claim 2, wherein the uniform iconography further comprises:
a group of symbols, each symbol indicating a status of a position having an original stock price, a current stock price, breakeven price, original strike price, current strike price, management fees and a potential profit, the symbols including:
a) a first symbol indicating current stock price is above the break even and original strike prices;
b) a second symbol indicating the current stock price is such that immediate closing of the position would be profitable;
c) a third symbol indicating that the current stock price is below the break even and original strike prices;
d) a fourth symbol indicating that the current stock price is above the breakeven price but lower than the original strike price due to management of position;
e) a fifth symbol indicating that the current stock price is above the breakeven price but below the original strike price;
f) a sixth symbol indicating that the current stock price is above the break even and strike prices but due to management of the position the current strike price is below the original strike price;
g) a seventh symbol indicating that the breakeven price is above the original stock price and original strike price but below the current strike price;
h) an eighth symbol indicating that the breakeven price is above the current strike price and the current strike price is above the original stock purchase price and original strike price;
I) a ninth symbol indicating that the current strike price is below the original strike price and the breakeven price is above the original strike price and original stock price.

4. The option trading system of claim 3, further comprising:
a help module operative to provide one member selected from the group consisting of: context sensitive explanations, iconography definitions, stock symbol lookup, option type lookup, financial terminology lookup and combinations thereof.

5. The option trading system of claim 4, further comprising:
a position closing module, operative to change an open position to a closed position, and in the event that a position is modified further operative to create a new open position, and add the new position to the associated option chain and add the closed position to the history chain;
an editable notes field associated with each such position, the position closing module further operative to prompt for input of additional information to such editable notes field, including text information, regarding the change in position.

6. The option trading system of claim 5, further comprising:
a note input module automatically entering into the editable notes field the first date, an indication of a position change.

7. The option trading system of claim 6, further comprising:
a message module operative to send a message, the message containing one member of the group consisting of: a) one such position, b) a link operative to directly display such position without displaying other modules of the option trading system and without displaying other positions, and c) combinations thereof.

8. The option trading system of claim 7, further comprising:
a non-volatile memory in a computer processor unit, the option trading system and such positions recorded upon the non-volatile memory, the option trading system further operative to change ownership of an option at opening and closing of an option.

9. The option trading system of claim 8, wherein:
the summary module is further operative to track and display at least one member selected from the group consisting of: stock ticker prices, position type, weight per stock in portfolio, sector allocation, industry allocation, income per position, total monthly income, weight of total return per position, portfolio progress through time, amount of open and closed income per position, income realized in closed positions, tax liability, charts based upon the relevant data, such dates for action, an expiry date, an option date, ex-dividend date, earnings date, date of position entry, length of time position has been open, date position closed, dividend pay date, and combinations thereof.

10. The option trading system of claim 1, wherein:
the first set of selectable parameters used by the market scanner module further comprises: stock price, ROI, down side protection, in-the-money or out-of-the-money options, expiration date, comparisons to moving averages, corporation market cap, corporation earnings, corporation PE ratio, corporation owners, corporation nationality, and combinations thereof;
and the second set of selectable parameters used by the options scanner module further comprises: stock price, ROI, down side protection, in-the-money or out-of-the-money options, expiration date, comparisons to moving averages, corporation market cap, corporation earnings, corporation PE ratio, corporation owners, corporation nationality, and combinations thereof.

11. A calculator module for use in an option trading package and for managing a portfolio in at least a first market, the portfolio having a plurality of positions in a plurality of financial products including at least a first and a second position in respective first and second financial products, each of the positions in turn having dates for action associated therewith and a position type associated therewith and a plurality of financial data associated therewith, the calculator module comprising:
a primary module operative to spawn first and second calculator module instances respectively associated with such first and second positions, each calculator module instance being given a calculator module instance type associated with such position type of such financial product, a calculator module instance data structure, a calculator module instance display format;
each calculator module instance having one calculator module instance type, each calculator module instance type being selected from the group consisting of: call, put, call spread, put spread, married put, collars, covered calls, puts, synthetic covered calls, naked calls, naked puts, straddle, strangle, calendar, diagonal, butterfly, iron butterfly, condor, iron condor, combo, futures options, futures spreads, futures option spreads, fence, barrier options, American option, Asian option, Bermudan option, Boston option, Canary option, European option, Israeli option, Russian option, Verde option, Parisian option, capped-style option, compound option, shout option, double option, swing option, exotic option, cross option, quanto option, exchange option, basket option, rainbow option, low exchange price option, lookback option, binary option, chooser option, forward start option, cliquet option and combinations thereof;
each calculator module instance data structure having a calculator module instance data structure type, each calculator module data structure type being associated with one calculator module instance type, each calculator module instance data structure having a subset group of variable fields relevant to such calculator module instance type, the subset group of variable fields containing such plurality of financial data associated with such position;
each calculator module instance display format being associated with one calculator module instance type;
a display module operative in a first mode to display the first calculator module instance using the associated calculator module instance display format, the display module in the first mode displaying at least first and second members of such plurality of financial data associated with such first position;
the calculator module operative to accept an input, the input altering at least one of such displayed members of such plurality of financial data associated with such first position, the calculator module further operative to recalculate all of such plurality of financial data associated with such first position based upon the input;
the display module operative in a second mode to display the first and second calculator module instances using their respective associated calculator module instance display format, the first and second calculator module instances being displayed side by side so as to allow easy comparison of the first and second positions;
the calculator module further comprising a closed positions module retaining and displaying such first position when such first position is closed, and furthermore displaying a chain of retained closed positions associated with such first financial product, the closed positions module further displaying a chronological index linked to such positions.

12. A position tracking module for use in an option trading package and for managing a portfolio having a plurality of positions in a plurality of financial products in at least a first market, the plurality of positions including at least a first and a second position in respective first and second financial products, each of the positions in turn having dates for action associated therewith and a position type associated therewith and a plurality of financial data associated therewith, the position tracking module comprising:
a database having a plurality of position data structures, each position data structure having a plurality of data fields, each position data structure being associated with a respective one of such positions;
a first data field of each associated position data structure being an indicator of the type of option trading strategy of such associated position;
a second data field of each associated position data structure being an indicator of the open or closed status of such associated position;
a third data field of each position data structure being an indicator of the identity of such financial product;
a fourth data field of each position data structure being an indicator of one member of the group consisting of: a) a previous such position, if any, in such financial product, which such previous position was altered to create such associated position, b) a later such position, if any, in such financial product, which such later position was created by altering such associated position, and c) combinations thereof;
the database retaining the position data structure associated with every one of such positions both before and after every alteration of such position and regardless of open and closed status, whereby every position ever held is retained in the dataset;
a chronological index of all retained position data structures;
a history chain, the history chain comprising a series of closed position data structures selected from the database, each member of the series of closed position data structures selected for being related to a particular one of such financial products, the closed position data structures of the history chain being linked in order according to the fourth data field of each one of the series of closed position data structures of the history chain;
a calculator module operative to spawn a plurality of calculator module instances, each one of the calculator module instances associated with a respective one position data structure of the option chain;
a message access module operative to send a message and if requested to display a calculator module associated with a respective one of the position data structures of the database without displaying other modules of such option trading package.

13. The position tracking module of claim 12, further comprising:
a plurality of calculator module instance types, each calculator module instance having a fifth data field indicating its type, each calculator module instance type being selected from the group consisting of: call, put, call spread, put spread, married put, collars, covered calls, puts, synthetic covered calls, naked calls, naked puts, straddle, strangle, calendar, diagonal, butterfly, iron butterfly, condor, iron condor, combo, futures options, futures spreads, futures option spreads, fence, barrier options, American option, Asian option, Bermudan option, Boston option, Canary option, European option, Israeli option, Russian option, Verde option, Parisian option, capped-style option, compound option, shout option, double option, swing option, exotic option, cross option, quanto option, exchange option, basket option, rainbow option, low exchange price option, lookback option, binary option, chooser option, forward start option, cliquet option and combinations thereof.

14. The position tracking module of claim 12, further comprising:
a help module operative to provide one member selected from the group consisting of: context sensitive explanations, iconography definitions, stock symbol lookup, option type lookup, financial terminology lookup and combinations thereof.

15. The position tracking module of claim 14, wherein:
the chronological index further comprises, an index by month and year.

16. The position tracking module of claim 12, wherein:
the position data structures further comprise a sixth data field indicating one member selected from the list consisting of: industry, bid, ask, purchase price, income, tax, commission, breakeven price, premium history, option activity history, dividends, and combinations thereof.

17. The position tracking module of claim 12, further comprising:
an option scanner module operative to search such first market by means of an electronic network according to a set of selectable parameters and to return any such options available on such first market which match the set of parameters and to update the option trading package;
the option scanner module operative to display an option chain;
the option chain comprising a list of such positions associated with a particular one of such financial products, each of such positions in the option chain being an active link operative when selected to activate the calculator module and spawn a new calculator instance automatically populated with data from such selected position.

18. The position tracking module of claim 12, further comprising:
a non-volatile memory in a computer processor unit, the position tracking module and database recorded upon the non-volatile memory, the position tracking module further operative to change ownership of an option at opening and closing of an option.

19. The position tracking module of claim 12, further comprising:
a cryptocurrency module operative to display monetary valuations denominated in a cryptocurrency, and further operative to transact trades by way of a cryptocurrency exchange network.

20. The position tracking module of claim 19, further comprising:
The cryptocurrency module operative to transact trades by way of the cryptocurrency exchange network when such trades a denominated in a currency other than the cryptocurrency.
